(19) United States
(12) Patent Application Publication
(10) Pub. No.: US 2017/0132515 A1
(43) Pub. Date: May 11, 2017

(54) LEARNING SYSTEM, LEARNING PROGRAM, AND LEARNING METHOD

(71) Applicant: DENSO CORPORATION, Kariya-city (JP)

(72) Inventors: Kensuke Yokoi, Kariya-city (JP); Ikuro Sato, Yokohama (JP); Hideki Niihara, Kawasaki (JP); Hiroki Nishimura, Tokyo (JP)

(21) Appl. No.: 15/347,638

(22) Filed: Nov. 9, 2016

(30) Foreign Application Priority Data
Nov. 10, 2015 (JP) 2015-220780

(51) Int. Cl. G06N 3/08; H04L 29/08

(52) U.S. Cl. CPC G06N 3/084; H04L 67/32

(57) ABSTRACT

In a learning system, a storage stores training data. At least one processor performs a plurality of processes. Each of the processes calculates, based on the at least one parameter at a present time and the training data, a differential value for updating the at least one parameter in accordance with backpropagation. Each of the processes calculates, based on the differential value and the at least one parameter at the present time, a transmission value to be transmitted to the other processes. Each of the processes updates, based on the transmission values transmitted from the other processes, the at least one parameter at the present time.

### CROSS REFERENCE TO RELATED APPLICATIONS

This application is based on and claims the benefit of priority from Japanese Patent Application 2015-220780 filed on Nov. 10, 2015, the disclosure of which is incorporated in its entirety herein by reference.

### TECHNICAL FIELD

The present disclosure relates to learning systems, learning programs, and learning methods for updating parameters of neural networks.

### BACKGROUND

Generic object recognition is one of the ultimate goals in image recognition research. This is to estimate categories, i.e. classes, to which objects, such as birds and vehicles included in images, belong. Recently, performance of generic object recognition has greatly improved due to the progress of convolution neural networks having many layers.

An example of such convolution neural networks is disclosed in the following non-patent document 1:

Ren Wu, Shengen Yan, Yi Shan, Qingqing Dang, and Gang Sun, “Deep Image: Scaling up Image Recognition”, arXiv: 1501.02876v2. (http://arxiv.org/pdf/1501.02876v2.pdf).

Various recognition algorithms have been proposed in the image recognition field. There is a tendency that the recognition performance of the convolution neural networks is higher than the recognition performance of each of the other recognition algorithms as the volume of data becomes enormous.

The convolution neural networks have higher ability of expressing a target model, but may cause overlearning or overtraining. The overlearning or overtraining means that a learning algorithm trained based on a training dataset excessively fits the features of the training dataset. However, a large increase of the volume of a training dataset up to a level that can avoid the occurrence of the overlearning enables the convolution neutral networks to be widely used.

### SUMMARY

The convolution neural networks have a great advantage in recognition performance, but also have a weakness of requiring long training time when they are trained. Learning of the convolution neural network means a task to optimize parameters, such as weights and biases, of the convolution neural network. Datasets associated with social networks or datasets associated with autonomous driving are an example of ever-increasing datasets. Using such an enormous volume of a dataset for learning a convolution neural network may increase the training time of the convolution neural network, resulting in a risk that the training may be unfinished within a realistically allowable time length. For example, learning of a convolution neural network based on such an enormous volume of a dataset may require one or more years.

Prolonged learning of a convolution neural network may reduce the practicality of the convolution neural network. This may result in users having no choice but to use recognition algorithms other than convolution neural networks.

That is, it is a very important issue in industry to speed up learning of convolution neural networks.

In view of the circumstances set forth above, one aspect of the present disclosure seeks to provide learning systems, learning programs, and learning methods, each of which is capable of speeding up learning of convolution neural networks.

According to a first exemplary aspect of the present disclosure, there is provided a learning system for updating at least one parameter for a neural network. The learning system includes a storage storing training data, and at least one processor configured to perform a plurality of processes. Each of the processes is configured to calculate, based on the at least one parameter at a present time and the training data, a differential value for updating the at least one parameter in accordance with backpropagation. Each of the processes is configured to calculate, based on the differential value and the at least one parameter at the present time, a transmission value to be transmitted to the other processes. Each of the processes is configured to update, based on the transmission values transmitted from the other processes, the at least one parameter at the present time.

Specifically, each process is configured to transmit the transmission value based on, in addition to the differential value, the at least one parameter at the present time to the other processes. This configuration therefore reduces the number of communications between the processes, thus updating the parameter in a shorter time.

According to a second exemplary aspect of the present disclosure, there is provided a learning system for updating at least one parameter for a neural network. The learning system includes a storage storing training data, and at least one processor configured to perform plural pairs of a differential process and a communication process. The differential process of each pair is configured to

1. Calculate, based on the at least one parameter at a present time and the training data, a differential value for updating the at least one parameter in accordance with backpropagation

2. Calculate, based on the differential value and the at least one parameter at the present time, a transmission value to be transmitted to the communication processes of the other pairs.

The communication process of each pair is configured to

1. Determine whether the differential process of the corresponding pair has completed calculation of the transmission value;

2. Transmit the transmission value to the communication processes of the other pairs when it is determined that the differential process of the corresponding pair has completed calculation of the transmission value

3. Transmit a part of the at least one parameter at the present time to the communication processes of the other pairs when it is determined that the differential process of the corresponding pair has not completed calculation of the transmission value;

4. Update the at least one parameter at the present time based on the transmission value transmitted from the communication process of at least one of the other pairs, and the part of the at least one parameter at the present time transmitted from the communication process of the remaining at least one of the other pairs.

This configuration enables the communication process of each pair to be separated from the differential process of the corresponding pair, and the transmission value completely calculated to be transmitted to the communication processes of the other pairs. This therefore enables the parameter to be updated in a shorter time.

According to a third exemplary aspect of the present disclosure, there is provided a learning system for updating at least one parameter for a neural network. The learning system includes a storage storing training data, and at least one processor configured to perform a plurality of processes. Each of the processes is configured to

1. Calculate, as a difference value, a compressed value of a difference between a first value of the at least one parameter at a present time that is referred to a first time and a second value of the at least one parameter at a second time that is later than the first time;

2. Calculate, based on the at least one parameter at the first time, the difference value, and the training data, a differential value for updating the at least one parameter in accordance with backpropagation;

3. Compress the differential value;

4. Calculate, based on the encoded differential value and the difference value, a transmission value to be transmitted to the other processes

5. Obtain the difference value based on the transmission values transmitted from the other processes and the transmission value calculated by the corresponding process

6. Update, based on a restored value of the difference value, the at least one parameter at the second time.

This configuration enables each process to transmit the differential value the other processes while the differential value is compressed. This therefore reduces the communications traffic among the processes.

According to a fourth exemplary aspect of the present disclosure, there is provided a learning system for updating at least one parameter for a neural network. The learning system includes a storage storing training data, and at least one processor configured to perform plural pairs of a differential process and a communication process. The differential process of each pair is configured to

1. Calculate, as a difference value, a compressed value of a difference between a first value of the at least one parameter at a present time that is referred to a first time and a second value of the at least one parameter at a second time that is later than the first time

2. Calculate, based on the at least one parameter at the first time, the difference value, and the training data, a differential value for updating the at least one parameter in accordance with backpropagation

3. Compress the differential value

4. Calculate, based on the encoded differential value and the difference value, a transmission value to be transmitted to the other processes.

The communication process of each pair is configured to

1. Determine whether the differential process of the corresponding pair has completed calculation of the transmission value

2. Transmit the transmission value to the communication processes of the other pairs when it is determined that the differential process of the corresponding pair has completed calculation of the transmission value

3. Transmit the difference value as the transmission value to the communication processes of the other pairs when it is determined that the differential process of the corresponding pair has not completed calculation of the transmission value

4. Obtain the difference value based on the transmission values transmitted from the other processes and the transmission value calculated by the differential process of the corresponding pair

5. Update, based on a restored value of the difference value, the at least one parameter at the second time.

This configuration enables the communication process of each pair to transmit the differential value the communication processes of the other pairs while the differential value is compressed. This therefore reduces the communications traffic among the processes.

According to a fifth exemplary aspect of the present disclosure, there is provided a program product usable for the learning system according to the second exemplary aspect, the program product includes a non-transitory computer-readable medium, and a set of computer program instructions embedded in the computer-readable medium. The instructions cause the at least one processor to perform at least one of

1. The differential process of each pair

2. The communication process of the corresponding pair.

According to a sixth exemplary aspect of the present disclosure, there is provided a learning method for updating at least one parameter for a neural network based on a plurality of processes executed by at least one processor. The learning method, by each of the processes, includes

1. Calculating, based on the at least one parameter at a present time and training data stored in a storage, a differential value for updating the at least one parameter in accordance with backpropagation

2. Calculating, based on the differential value and the at least one parameter at the present time, a transmission value to be transmitted to the other processes

3. Updating, based on the transmission values transmitted from the other processes, the at least one parameter at the present time.

According to a seventh exemplary aspect of the present disclosure, there is provided a learning method for updating at least one parameter for a neural network based on plural pairs of a differential process and a communication process executed by at least one processor. The learning method includes

1. Calculating, by the differential process of each pair based on the at least one parameter at a present time and training data stored in a storage, a differential value for updating the at least one parameter in accordance with backpropagation

2. Calculating, by the differential process of each pair based on the differential value and the at least one parameter at the present time, a transmission value to be transmitted to the communication processes of the other pairs

3. Determining, by the communication process of each pair, whether the differential process of the corresponding pair has completed calculation of the transmission value

4. Transmitting, by the communication process of each pair, the transmission value to the communication processes of the other pairs when it is determined that the differential process of the corresponding pair has completed calculation of the transmission value

5. Transmitting, by the communication process of each pair, a part of the at least one parameter at the present time to the communication processes of the other pairs when it is determined that the differential process of the corresponding pair has not completed calculation of the transmission value

6. Updating, by the communication process of each pair, the at least one parameter at the present time based on the transmission value transmitted from the communication process of at least one of the other pairs, and the part of the at least one parameter at the present time transmitted from the communication process of the remaining at least one of the other pairs.

According to an eighth exemplary aspect of the present disclosure, there is provided a learning method for updating at least one parameter for a neural network based on a plurality of processes executed by at least one processor. The learning method, by each of the processes, includes

1. Calculating, as a difference value, a compressed value of a difference between a first value of the at least one parameter at a present time that is referred to a first time and a second value of the at least one parameter at a second time that is later than the first time

2. Calculating, based on the at least one parameter at the first time, the difference value, and training data stored in a storage, a differential value for updating the at least one parameter in accordance with backpropagation

3. Comparing the differential value

4. Calculating. based on the encoded differential value and the difference value, a transmission value to be transmitted to the other processes

5. Obtaining the difference value based on the transmission values transmitted from the other processes and the transmission value calculated by the corresponding process

6. Updating, based on a restored value of the difference value, the at least one parameter at the second time.

According to a ninth exemplary aspect of the present disclosure, there is provided a learning method for updating at least one parameter for a neural network based on plural pairs of a differential process and a communication process executed by at least one processor. The learning method includes

1. Calculating, by the differential process of each pair, a difference value indicative of a compressed value of a difference between a first value of the at least one parameter at a present time that is referred to a first time and a second value of the at least one parameter at a second time that is later than the first time

2. Calculating, by the differential process of each pair based on the at least one parameter at the first time, the difference value, and training data stored in a storage, a differential value for updating the at least one parameter in accordance with backpropagation

3. Compressing, by the differential process of each pair, the differential value

4. Calculating, by the differential process of each pair based on the encoded differential value and the difference value, a transmission value to be transmitted to the other processes

5. Determining, by the communication process of each pair, whether the differential process of the corresponding pair has completed calculation of the transmission value

6. Transmitting, by the communication process of each pair, the transmission value to the communication processes of the other pairs when it is determined that the differential process of the corresponding pair has completed calculation of the transmission value

7. Transmitting, by the communication process of each pair, the difference value as the transmission value to the communication processes of the other pairs when it is determined that the differential process of the corresponding pair has not completed calculation of the transmission value

8. Obtaining, by the communication process of each pair, the difference value based on the transmission values transmitted from the other processes and the transmission value calculated by the differential process of the corresponding pair

9. Updating, by the communication process of each pair based on a restored value of the difference value, the at least one parameter at the second time.

The above sixth to ninth exemplary aspects substantially achieve the advantageous effects achieved by the respective first to fourth exemplary aspects.

### BRIEF DESCRIPTION OF THE DRAWINGS

Other aspects of the present disclosure will become apparent from the following description of embodiments with reference to the accompanying drawings in which:

FIG. 1 is a block diagram schematically illustrating an example of the structure of a convolution neural network according to the first embodiment of the present disclosure;

FIG. 2 is a flowchart schematically illustrating the procedure of a learning approach based on a comparison example assuming that three processes are parallelly carried out;

FIG. 3 is a flowchart schematically illustrating an example of the procedure of a learning approach based on the first embodiment of the present disclosure in the same assumption as the comparison example;

FIG. 4 is a block diagram schematically illustrating an example of the hardware structure of a learning system that performs the learning approach illustrated in FIG. 3;

FIG. 5 is a flowchart schematically illustrating operations carried out by a differential process illustrated in FIG. 4;

FIG. 6 is a flowchart schematically illustrating the operations carried out by a communication process illustrated in FIG. 4;

FIG. 7 is a timing chart schematically illustrating how the differential processes and the communication processes illustrated in FIG. 4 operate according to the first embodiment;

FIG. 8A to 8D illustrate respective typical filters each having a predetermined size of 5×5 pixels according to the second embodiment of the present disclosure;

FIG. 9 is a schematic diagram schematically illustrating filter sharing according to the second embodiment;

FIG. 10A is a diagram schematically illustrating a filtering process by a filter having 2×2 pixels according to the second embodiment;

FIG. 10B is a part of a network diagram showing synapses, i.e. connections, between input images and output images according to the second embodiment;

FIG. 11 is a flowchart schematically illustrating operations carried out by a differential process according to the third embodiment of the present disclosure;

FIG. 12 is a flowchart schematically illustrating operations carried out by a communication process according to the third embodiment;

FIG. 13A is a diagram describing an example of matrixes according to the third embodiment;

FIG. 13B is a diagram describing the matrixes illustrated in FIG. 13A according to the third embodiment;

FIG. 14 is a diagram schematically illustrating an expression according to the third embodiment;

FIG. 15 is a flowchart schematically illustrating operations carried out by a differential process according to the fourth embodiment of the present disclosure;

FIG. 16 is a flowchart schematically illustrating operations carried out by a communication process according to the fourth embodiment; and

FIG. 17 is a block diagram schematically illustrating an example of the hardware structure of a learning system according to the fifth embodiment of the present disclosure.

### DETAILED DESCRIPTION OF EMBODIMENT

The following describes embodiments of the present disclosure with reference to the accompanying drawings. In the embodiments, like parts between the embodiments, to which like reference characters are assigned, are omitted or simplified in description to avoid redundant description.

### First Embodiment

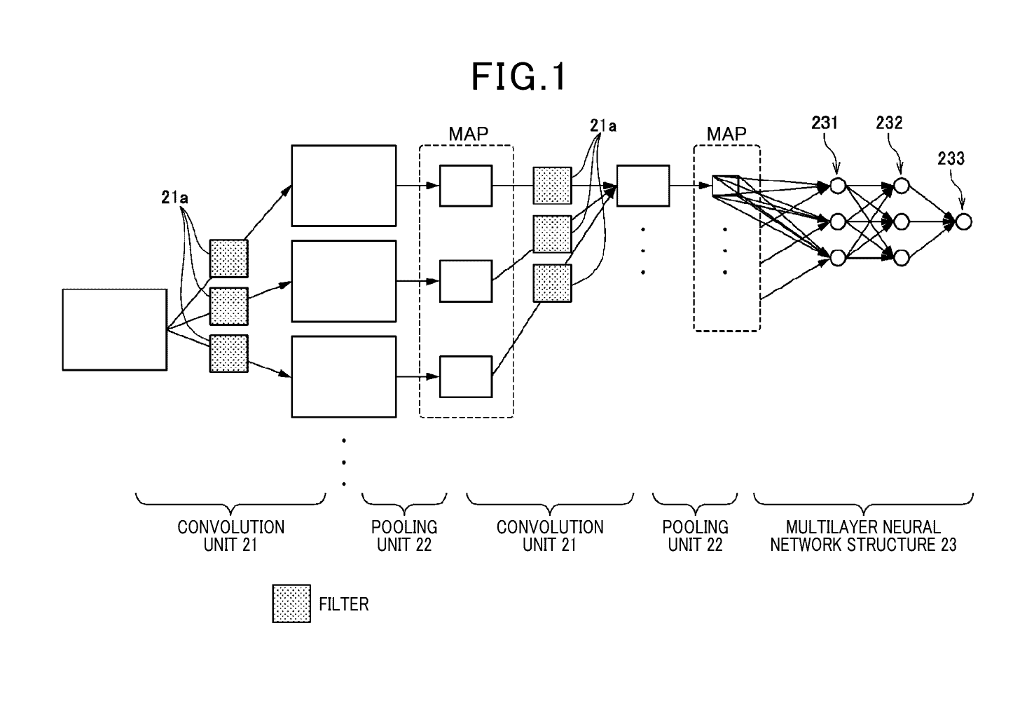

FIG. 1 schematically illustrates an example of the structure of a convolution neural network (CNN). The CNN includes at least one pair of the set of convolution units 21 and the set of pooling units 22, and a multilayer neural network structure 3. In FIG. 1, the first stage of the set of convolution units 21 and the set of pooling units 22, and the second stage of the set of convolution units 21 and the set of pooling units 22 are provided in the CNN as an example.

An image I having a predetermined two-dimensional pixel size, which is a recognition target of the CNN, is input to the convolution units 21 of the first stage. The multilayer neural network structure 3 outputs the result of recognition of the input image I by the CNN.

Each of the convolution units 21 of the first stage convolves an input image, such as the input image I as the recognition target, using at least one filter 21a, and non-linearly maps the result of the filtering. Each of the convolution units 21 of the second stage convolves an input image, which is a feature map described later, using at least one filter 21a, and non-linearly maps the result of the filtering.

Each of the filters 21a has a predetermined pixel size lower than the pixel size of an input image; each pixel of the corresponding filter 21a has a weight, i.e. weight value. The weight of each pixel of each of the filters 21a can be biased.

Each of the pooling units 22 downsamples the output image signal of the corresponding one of the convolution units 21 to lower resolution of the output image signal, thus generating a feature map.

The multilayer neural network structure 23 includes an input layer 231, at least one intermediate layer, i.e. at least one hidden layer, 232, and an output layer 233. Each of the input layer and the at least one hidden layer 232 includes plural units, i.e. neurons. Each unit, also called a node, serves as, for example, a functional module, such as a hardware module like a processor. The output layer 233 includes at least one unit, i.e. at least one node.

To the input layer 231, the feature maps output from the pooling units 22 of the last stage, that is, the second stage according to the first embodiment, are input.

Each unit in the input layer 231 receives the feature maps input thereto from the pooling units 22 of the last stage, and sends the received feature maps to all units in the at least one hidden layer 232.

Each unit in the at least one hidden layer 232 is connected to all the units in the input layer 231. Each unit in the at least one hidden layer 232 receives feature maps input thereto from all the units in the input layer 231, and multiplies each of the feature maps by a weight defined for a corresponding one of the units in the input layer 231.

If there are N hidden layers 232 (N is an integer equal to or more than 2), each unit in the i-th hidden layer 232 is connected to all the units in the (i−1)-th hidden layer (i is set to any one of 2 to N). Each unit in the i-th hidden layer 232 receives feature maps input thereto from all the units in the (i−1)-th hidden layer 232, and multiplies each of the feature maps by a weight defined for a corresponding one of the units in the (i−1)-th hidden layer 232.

The at least one unit in the output layer 233 is connected to all the units in the last hidden layer 232. The at least one unit in the output layer 233 receives feature maps input thereto from all the units in the last hidden layer 232. Then, the at least one unit in the output layer 233 multiplies each of the feature maps by a weight defined for a corresponding one of the units in the last hidden layer 232, thus obtaining the result of recognition of the input image I by the CNN.

The weights of the filters 21a and the weights of the multilayer neural network structure 23 represent parameters of the CNN to be trained. The following the weights included in the CNN are referred to as weights W.

The first embodiment aims to train the weights W for a shorter time. The learning or training means updating of the weights W of the CNN to enable the CNN to return an ideal output when a target image as a recognition target of the CNN is input to the CNN.

A plurality of training datasets are used for the learning; each of the training datasets includes target images and corresponding pieces of output data. Each of the pieces of output data represents a predetermined ideal output for a corresponding one of the target images.

Before the learning of the CNN, an evaluation function, such as a square error function or cross entropy function, is defined for each of the training datasets. The evaluation function defined for a training dataset quantifies the deviation of the output of the CNN when a target image of the training dataset is input to the CNN from the ideal output of the CNN corresponding to the target image.

The sum of the evaluation functions provide for all the training datasets is defined as a cost function E(W). The cost function E(W) is expressed as a function of the weights W of the CNN. That is, the lower the cost function E(W) is, the higher the evaluation of the CNN.

In other words, the learning also means updating of the weights W of the CNN to minimize the cost function E(W) of the CNN.

The first embodiment uses backpropagation, an abbreviation for “backward propagation of errors” as one type of gradient methods for minimizing the cost function E(W).

The backpropagation repeats updating of the weights W of the CNN many times. One updating of each weight W is represented by the following equation (1):

W←W−r*dW (1)

Where r represents a scalar learning speed, and dW represents the differential value of the cost function with respect to each weight W. Note that the expression W←W−r*dW having the symbol “←” represents that the value W−r*dW is substituted into the weight W.

Specifically, updating of each weight W uses a current value of the corresponding weight W and the differential value dW. The learning speed r can be reduced every updating.

A method using the differential value dW calculated based on all the training datasets for one updating of each weight W is referred to as a batch learning. A method using an approximate value of the differential value dW, which is calculated based on some of the training datasets, is referred to as mini-batch learning. Recently, mini-batch learning is usually used, because the mini-batch learning has a higher convergence rate and a higher generalization capability than the batch learning. Note that the generalization capability of the CNN represents the recognition capability with respect to an image that is not included in the training datasets.

It is necessary for using the mini-batch learning to determine the mini-batch size. The mini-batch size represents the number of pieces of training data used for one updating of the weights W, i.e. calculation of the differential value dW. The proper mini-batch size, which depends on a problem to be solved by the CNN, is set to be within the range from 1 to approximately 1000. Experience shows that the mini-batch size has a proper value, i.e. a preferred value. If the mini-batch size were set to a value largely exceeding the proper value, the convergence rate and the generalization capability could be lowered. That is, increasing the mini-batch size not necessarily contribute to higher convergence rate and generalization capability. It is well known that the proper value of the mini-batch size is well below the total number of all pieces of the training data.

Although the above non-patent document 1 describes no specific learning approaches in detail, the following describes a learning approach assumed by the inventors based on the non-patent document 1 as a comparison example of the first embodiment.

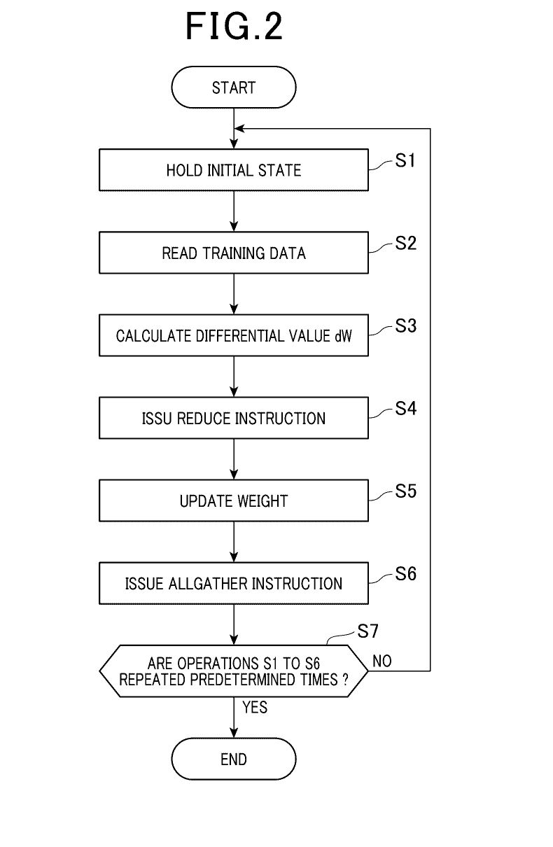

FIG. 2 is a flowchart schematically illustrating the procedure of the learning approach based on the comparison example assuming that three processes A to C are parallelly carried out. Note that the inventors estimate that a normalized message passing interface (MPI) is used for communication between the processes A to C.

First, each of the processes A to C holds a corresponding weight W as its initial state in accordance with the following expression (2) in step S1.

Process A W=[W1,W2,W3]

Process B W=[W1,W2,W3]

Process C W=[W1,W2,W3] (2)

The weight W are divided by the same number of the processes, i.e. 3, into partitions 1 to 3; the partitions 1 to 3 respectively correspond to weights W1 to W3. The weights W1 to W3 have substantially the same number of bytes.

Next, the processes A to C respectively read respective training datasets A to C in accordance with the following expression (3) in step S2:

Process A read a training dataset A

Process B read a training dataset B

Process C read a training dataset C (3)

Each of the training datasets A to C includes randomly sampled one or more pieces of training data. The number of pieces of training data of each of the training datasets corresponds to the mini-batch size. For example, when each of the training datasets A to C includes five pieces of training data, the mini-batch size is 15, because the number of the processes is 3.

The processes A to C respectively calculate differential values dWA, dWB, and dWC based on backpropagation in accordance with the following expressions (4) in step S3:

Process A dWA=[dWA1,dWA2,dWA3]

Process B dWB=[dWB1,dWB2,dWB3]

Process C dWC=[dWC1,dWC2,dWC3] (4)

That is, the differential value dWA is comprised of differential values dWA1, dWA2, and dWA3 respectively corresponding to the partitions 1, 2, and 3. The differential value dWA1 is calculated based on the weight W1 and the training dataset A. The other differential values dWA2 and dWA3 are calculated like the differential value dWA1. The other differential values dWB and dWC are also calculated like the differential value dWA. Specifically, each of the differential values has a corresponding one of the indexes A to C respectively representing the processes A to C, and has a corresponding one of the indexes 1 to 1 respectively representing the partitions 1 to 3.

When the calculation of the corresponding one of the differential values dWA, dWB, and dWC has been completed, each of the processes A to C issues a REDUCE instruction including addition as the kind of calculation in the MPI in accordance with the following expressions (5) in step S4:

Process A dW1=[dWA1+dWB1+dWC1]

Process B dW2=[dWA2+dWB2+dWC2]

Process C dW3=[dWA3+dWB3+dWC3] (5)

That is, the differential values dWA, dWB1, and dWC1, each of which represents the partition 1 of the corresponding one of the processes A, B, and C, are transmitted to the process A, so that the differential values dWA, dWB1, and dWC1 are added to each other, resulting in the differential dW1 being calculated. The other differential values dW2 and dW3 can be calculated in the same manner as the differential dW1.

Note that the comparison example transmits only the differential values, and transmits no weights themselves. The REDUCE instruction causes the first communications to be carried out.

As described in the expressions (6), the process A updates the weight W1 at the present time based on the weight W1 and the differential value dW1, and similarly each of the processes B and C updates the corresponding one of the weights W2 and W3 at the present time:

Process A W1←W1−r*dW1=W1−r(dWA1+dWB1+dWC1)

Process B W2←W2−r*dW2=W2−r(dWA2+dWB2+dWC2)

Process C W3←W3−r*dW3=W3−r(dWA3+dWB3+dWC3) (6)

Finally, each of the processes A to C issues ALLGATHER instruction in the MPI in accordance with the following expressions (7) in step S6:

Process A W←[W1,W2,W3]

Process B W←[W1,W2,W3]

Process C W←[W1,W2,W3] (7)

This enables the weights W1 to W3 to be distributed to all the processes A to C. The ALLGATHER instruction results in the second communications being generated.

The procedure of the learning approach in the comparison example repeats the operations in steps S1 to S6 necessary times in step S7, and thereafter is terminated. Note that when the procedure of the learning approach is terminated is, for example, when the cost function E(W) of the processes A to C has converged or when the accuracy of recognition based on the processes A to C is not improved.

The comparison example however may provide the following problems.

First, the comparison example has the first problem that the learning speed depends on one process that has the slowest calculation rate of the corresponding differential values in all the processes. This is because the REDUCTION instruction is required to be issued after all the processes have completed calculation of the differential values dWA, dWB, and dWC.

Second, the comparison example has the second problem that the learning time increases as the network structure increases. This is because an increase of the network structure results in

(1) An increase of forward propagation and backpropagation of data, causing time for calculating the differential values to increase

(2) An increase of the number of weights W to increase the communication time.

Third, even if the number of the processes increases, it is difficult to accelerate the learning as the third problem. As seen in the descriptions of step S2, increasing the number of the processes increases the mini-batch size. However because the mini-batch size has a proper upper limit, if the number of the processes exceeded the proper upper limit, the learning time of the CNN could increase and/or the recognition performance of the CNN could be deteriorated.

Additionally, the comparison example requires two communications, i.e. the REDUCE instruction and the ALLGATHER instruction, contributing to the difficulty in accelerating the learning.

In view of the circumstances, the first embodiment provides a new learning approach that has

(1) Lower degree of dependence of the learning speed on the slowest process of calculating the corresponding differential values

(2) Lower learning time even if the network structure is upsized.

(3) Lower communication times

(4) Higher learning speed even if the number of processes increases.

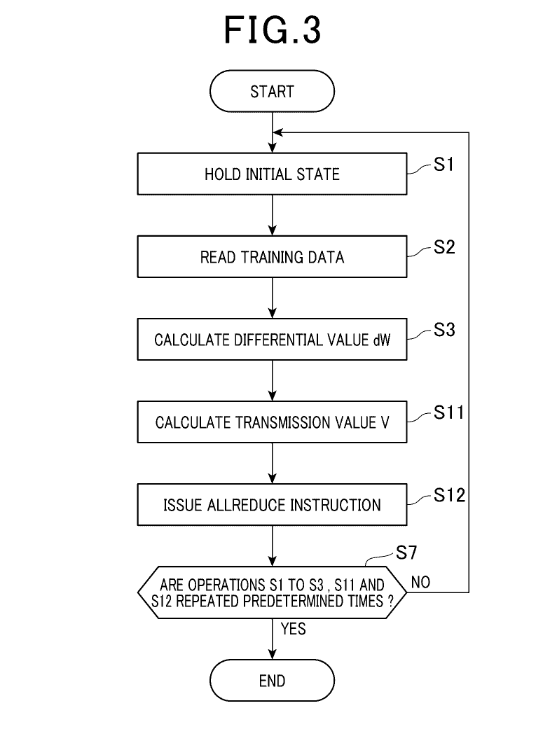

FIG. 3 is a flowchart schematically illustrating an example of the procedure of the learning approach based on the first embodiment of the present disclosure in the same assumption as the comparison example.

Descriptions of steps of the learning approach according to the first embodiment, which are identical to the corresponding steps of the comparison example, are omitted.

After the differential values dWA, dWB, and dWC are calculated in step S3, each of the processes A, B, and C calculates a corresponding one of transmission values VA, VB, and VC to be transmitted to the other processes in accordance with the following expressions (8) in step S11:

Process A VA=[W1−r*dWA1,−r*dWA2,−r*dWA3]

Process B VB=[−r*dWB1,W2−r*dWB2,−r*dWB3]

Process C VC=[−r*dWC1,−r*dWC2,W3−r*dWC3] (8)

Next, each of the processes A to C issues an ALLREDUCE instruction including addition as the kind of calculation in the MPI in accordance with the following expressions (9) in step S12:

Process A W←VA+VB+VC=[W1−r(dWA1+dWB1+dWC1),W2−r(dWA2+dWB2+dWC2),W3−r(dWA3+dWB3+dWC33)]

Process B W←VA+VB+VC

Process C W←VA+VB+VC (9)

This enables the other processes to calculate the sum of the transmission values VA, VB, and VC, so that updated weights W are obtained.

The ALLREDUCE instruction results in the first communications being generated.

The expressions (9) are equivalent to the expressions (6) and (7). That is, the procedure of the learning approach based on the first embodiment of the present disclosure enables the results, which are the same results as the comparison example using only one communications.

Note that, in step S11, each of the processes A, B, and C can calculate a corresponding one of transmission values VA, VB, and VC to be transmitted to the other processes in accordance with the following expressions (8′):

Process A VA=[(W1)/3−r*dWA1,(W2)/3−r*dWA2,−(W3)/3−r*dWA3]

Process B VB=[(W1)/3−r*dWB1,(W2)/3−r*dWB2,−(W3)/3−r*dWB3]

Process C VC=[(W1)/3−r*dWC1,(W2)/3−r*dWC2,−(W3)/3−r*dWC3] (8′)

Specifically, the partition 1 of each of the transmission values VA to VC can include the value (W1)/3, which is obtained by dividing the weight W1 by 3, i.e. the number of the processes A to C. Each of the other partitions is similar to the partition 1. The transmission values VA, VB, and VC in the expressions (8′) enable the updated weights W to be obtained.

That is, the transmission value VA is calculated based on the differential values dWA1, dWA2, and dWA3 and the weight W1 (or weights W1 to W3), and the transmission value VB is calculated based on the differential values dWB1, dWB2, and dWB3 and the weight W2 (or weights W1 to W3). Moreover, the transmission value VC is calculated based on the differential values dWC1, dWC2, and dWC3 and the weight W3 (or weights W1 to W3). These calculations enable the ALLREDUCTION instruction to obtain the weights illustrated in the expressions (9). As a wide difference between the comparison example and the first embodiment, each of the transmission values VA, VB, and VC includes a corresponding one of the current weights W1, W2, and W3 in addition to corresponding differential values.

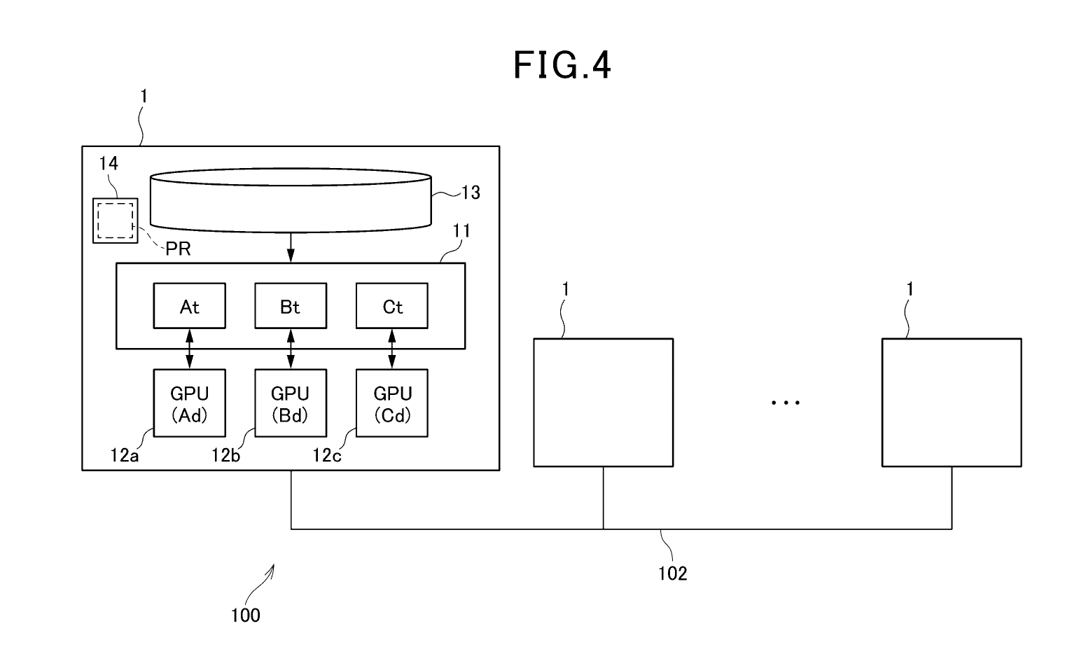

FIG. 4 is a block diagram schematically illustrating an example of the hardware structure of a learning system 100 that performs the learning approach illustrated in FIG. 3.

The learning system 100 is comprised of n nodes 1 connected to each other via buses 102; n is an integer equal to or higher than 1. The nodes 1 enable data communications to be carried out therebetween. In the following, the theoretical values of the communication rates between the nodes 1 are constant, but they can be different from each other.

Each of the nodes 1 is, for example, a single processor. Each node 1 is comprised of a central processing unit (CPU) 11, three graphics processing units (GPUs) 12a to 12c, and a storage 13, the CPU 11 is communicable with the GPUs 12a to 12c and the storage 13. All pieces of training data are divided into n datasets. If the n nodes 1 are labeled by 1a1 to 1an and the n datasets are also labeled by the first training dataset to the nth dataset, the storage 13 of the kth node 1 (1≦k≦n) stores the kth dataset. The number of pieces of training data included in each dataset is set to be equal to or larger than a proper mini-batch size.

Note that the hardware structure of the learning system illustrated in FIG. 4 is an example. For example, each node 1 can include any number of CPUs and any number of GPUs. The storage 13 of each node 1 can be designed as an external storage with respect to the corresponding node 1. A single storage to which all nodes 1 are communicably accessible can store all pieces of training data. Each node 1 is capable of performing quick access to the training data.

Each node 1 includes the MPI, and is capable of parallelly carrying out a plurality of processes. Note that the term “node” represents the unit of hardware processors, and the term “process” represents the unit of software programs PR that can be parallelly carried out by the corresponding node.

For example, each node 1 includes a memory 14 storing software programs PR. At least one of the software programs PR causes the CPU 11 to perform the corresponding one of the communication processes At, Bt, and Ct. Similarly, at least one of the software programs PR causes each of the GPUs 12a, 12b, and 12c to perform the corresponding one of the differential processes Ad, Bd, and Cd.

The first embodiment is configured to divide the operations in FIG. 3 into the first group of operations, and the second group of operations. The first embodiment also performs a differential process to carry out the first group of operations, and performs a communication process to carry out the second group of operations.

The GPUs 12a to 12c of one node 1, referred to as a first node 1, are operative to carry out respective differential processes Ad to Cd.

Each of the differential processes Ad to Cd of the first node 1 specifically executes

(1) The holding operation of the initial-state in step S1

(2) The reading operation of the corresponding training dataset in step S2

(3) The calculating operation of the corresponding differential values in step S3

(4) The calculating operation of the corresponding transmission value in step S11.

The CPU 11 of the first node 1 is operative to carry out communication processes At, Bt, and Ct respectively paired with the differential processes Ad, Bd, and Cd.

Each of the communication processes At to Ct specifically executes the ALLREDUCE instruction in step S12.

As described above, it is preferable that the GPUs 12a to 12c respectively perform the differential processes Ad to Cd, and the CPU 11 performs the communication processes At to Ct. Each differential process requires a large amount of throughputs, because the corresponding differential process includes convolution operations and matrix product operations. In view of this, each of the GPUs 12a to 12c executes the corresponding differential process, resulting in speedup of the execution of the corresponding differential process.

In addition, each of the GPUs 12a to 12c is configured not to perform the communication process, resulting in reduction of memory transfer. This enables the number of occurrences of the communications per unit of time between the communication processes to increase.

As described above, the first embodiment has a specific feature that the communication processes At to Ct successively issue the ALLREDUCE instructions without waiting for the differential processes Ad to Cd to completely calculate the respective transmission values in step S11. This specific feature, which is described in detail later, enables the learning of each weight W of the CNN to be faster.

Note that the present disclosure describes, for example, that a differential process reads training data, but this is very simple description. Actually, a node 1, i.e. each processor, such as CPU 11 or GPUs 12a to 12c, runs a program corresponding to a differential process to read training data. In other words, a differential process includes a process of reading training data.

In addition, note that the GPUs 12a to 12c of another node 1, referred to a second node 1, are operative to carry out respective differential processes Dd, Ed, and Fd that are identical to the respective differential processes Ad to Cd. The CPU 11 of the second node 1 is operative to carry out communication processes Dt, Et, and Ft that are identical to the respective communication processes At to Ct. The GPUs 12a to 12c of each of the remaining nodes 1 are operative to similarly perform respective differential processes Dd, Ed, and Fd that are identical to the respective differential processes Ad to Cd. The CPU 11 of each of the remaining nodes 1 are operative to perform communication processes that are identical to the respective communication processes At, Bt, and Ct. Each communication process in one node 1 is capable of communicating with anther communication process located in the same node 1 or another node 1 in the same manner.

The following describes a pair of the differential process Ad and the communication process At. The other pairs of the differential processes Bd, Cd and the communication processes Bt, Ct are identical to the pair of the differential process Ad and the communication process At unless otherwise stated.

First, variables Flag, Array 0, Array1, and Array2, which are transferable between the differential process Ad and the communication process At, are defined.

The variable Flag is a binary variable having 0 as its initial value. Each of the variables Array0, Array 1, and Array2 is an array variable whose size is identical to the size of the corresponding weight W. The weight W at the present time is stored in the variable Array0. For example, at the first time, an initial weight Wini is stored in the variable Array0.

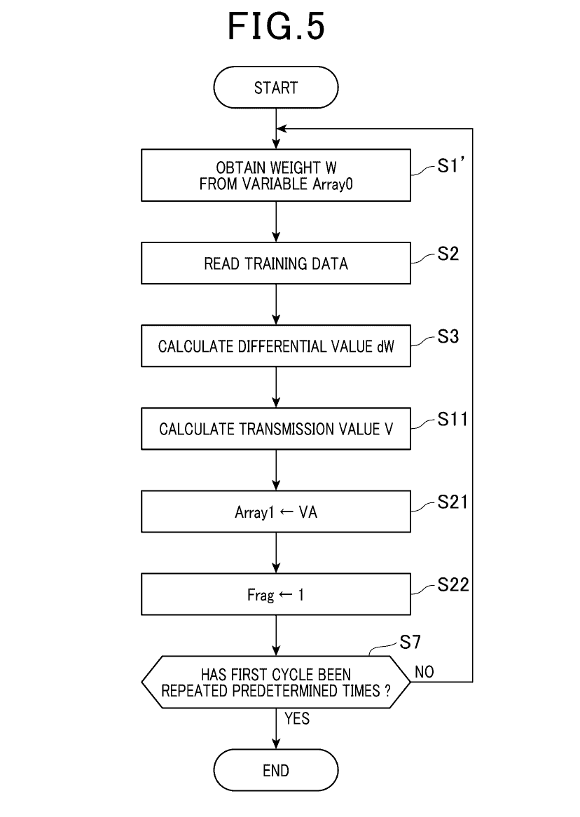

FIG. 5 is a flowchart schematically illustrating the following operations carried out by the differential process Ad.

First, the differential process Ad obtains the weight W stored in the variable Array0 at the present time in step S1′. Next, the differential process Ad reads predetermined pieces of training data stored in the storage 13 in step S2. The number of pieces of training data read from the storage 13 is determined to satisfy the condition that calculated differential values based on the pieces of training data can be stored in the memory of the GPU 12a. Usually, the pieces of training data read from the storage 13 at a time are small, because the memory capacity of the GPU 12a is not very large. That is, the number of the pieces of training data read from the storage 13 at a time is lower than the proper mini-batch size.

In step S3, the differential process Ad calculates the differential value dW, and calculates the transmission value VA based on the differential value dW in step S11. Thereafter, the differential process Ad stores the transmission value VA in the variable Array1 in step S21, and sets the variable Flag to 1 in step S22. That is, when the variable Flag is set to 1, this means that the calculation of the transmission value VA has been completed.

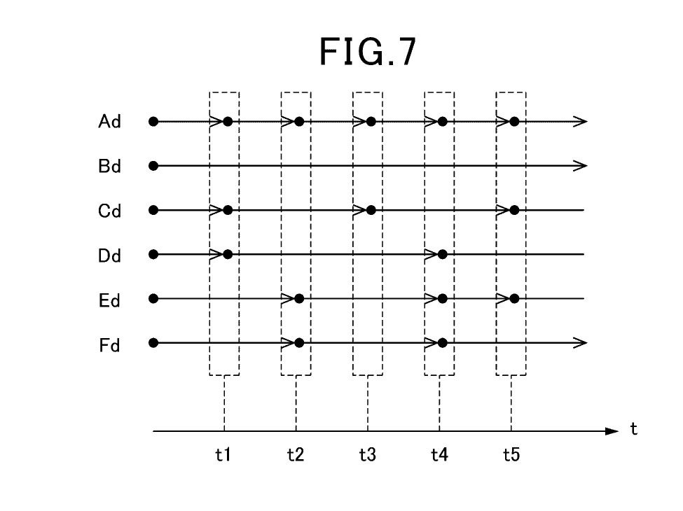

The operations from step S1 to S22 constitute one cycle, i.e. one loop, and the differential process Ad repeats the cycle, referred to as a first cycle, until a predetermined number has been repeated (see step S7). Specifically, the differential process Ad calculates the transmission value VA in accordance with the above expression (8). The other differential processes Bd and Cd each perform the same operations steps S1, S2, S3, S11, S21, S22, and S7 like the differential process Ad. The time required for the differential process Ad to perform the first cycle is longer than the time required for the communication process At to perform a second cycle illustrated in FIG. 7 described later. Specifically, in normal CNN distributes systems, the time required to perform one differential-value calculation is longer than the time required to perform one weight transfer. This is because the processing load of the convolution operation is large. Independently, the differential process Ad repeats the first cycle illustrated in FIG. 5 in asynchronization with the communication process At.

Note that the routine illustrated in FIG. 5 is configured such that the differential process Ad directly rewrites the weight W and the transmission value VA, but the routine can be configured such that the differential process Ad can rewrite the weight W and the transmission value VA using pointers.

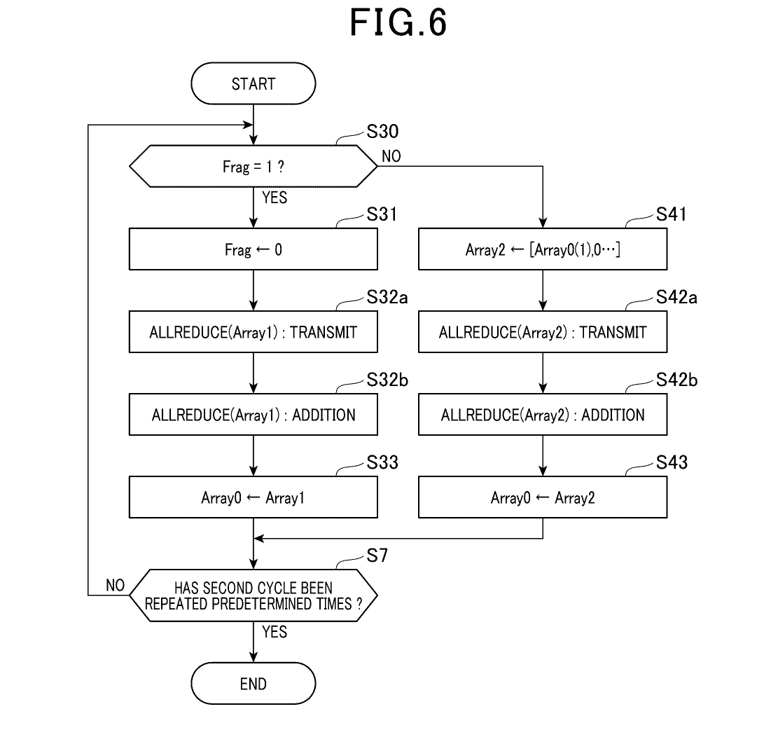

FIG. 6 is a flowchart schematically illustrating the operations carried out by the communication process At.

The communication process At periodically issues the ALLREDUCE instruction to transmit values to another communication process (see step S12 in FIG. 3). The values transmitted by the ALLREDUCE instruction vary depending on a value of the variable Flag each time the ALLREDUCE instruction is issued.

Specifically, when issuing the ALLREDUCE instruction, the communication process At determines whether the variable Flag is 1 in step S30. When determining that the variable Flag is 1 (YES in step S30), the communication process At determines that the differential process Ad has completed the calculation of the transmission value VA. Then, the communication process At transmits the transmission value VA to the other communication processes Bt, Ct, Dt, . . . .

Specifically, the communication process At resets the variable Flag from 1 to 0 in step S31. Then, the communication process At issues the ALLREDUCE instruction that transmits, to the other communication processes Bt, Ct, Dt, . . . , the variable Array1 in which the transmission value VA has been stored in step S21 of FIG. 5, in step S32a.

Otherwise, when determining that the variable Flag is 0 (NO in step S30), the communication process At determines that the differential process Ad has not completed the calculation of the transmission value VA yet. Then, the communication process At transmits a part of the weight W at the present time to the other communication processes Bt, Ct, Dt, . . . .

Specifically, the communication process At determines a value of sets the variable Array2 in accordance with the following expression (10) in step S41:

Array2←[Array0(1),0,0, . . . ] (10)

Where Array0(1) represents the first partition of the variable Array0. Specifically, the expression (10) shows that

(1) The first partition W1 of the weight W stored in the variable Array0 at the present time is stored in the first partition of the variable Array2

(2) 0 are stored in the other partitions of the variable Array2.

Following the operation in step S41, the communication process At issues the ALLREDUCE instruction that transmits, to the other communication processes Bt, Ct, Dt, . . . , the variable Array2 in step S42a.

The communication process At in the operation in step S32a receives the variable Array1 from each of the other communication processes Bt, Ct, Dt, . . . in addition to transmitting the Array1. Similarly, the communication process At in the operation in step S42a receives the variable Array2 from each of the other communication processes Bt, Ct, Dt, . . . in addition to transmitting the Array2

Specifically, the communication process At receives

(1) The variable Array1 from at least one communication process paired to at least one differential process that has completed calculation of the transmission value VA

(2) The variable Array2 from at least one communication process paired to at least one differential process that has not completed calculation of the transmission value VA.

For example, the communication process At receives, from the communication process Bt, the Array1 equal to the transmission value VB or the Array2 equal to [0, Array0(2), 0, . . . ]. The other communication processes perform the same operations as the communication process At.

When the variable Flag is 1, the communication process At calculates, based on the ALLREDUCE instruction, the sum of

1. The variable Array1 of the communication process At

2. At least one variable Array1 and at least one variable Array2 received from the other communication processes Bt, Ct, Dt, . . . .

The communication process At stores the calculated sum into the variable Array1 in step S32b. Because the corresponding differential value has been stored in the Array1, the weight W is updated.

Thereafter, the communication process At stores the variable Array1 into the variable Array0 in step S33. This enables the updated newest weight W to be stored in the variable Array0, resulting in the variable Array0 being returned to the initial state.

Otherwise, when the variable Flag is 0, the communication process At calculates, based on the ALLREDUCE instruction, the sum of

1. The variable Array2 of the communication process At

2. At least one variable Array1 and at least one variable Array2 received from the other communication processes Bt, Ct, Dt, . . . .

The communication process At stores the calculated sum into the variable Array2 in step S42b. Because the corresponding differential value has been stored in the Array2, the weight W is updated.

Thereafter, the communication process At stores the variable Array2 into the variable Array0 in step S43. This enables the updated newest weight W to be stored in the variable Array0, resulting in the variable Array0 being returned to the initial state.

The operations from the issuance of the ALLREDUCE instruction to the update of the weight W constitute one second cycle, and the communication process At repeats the second cycle until a predetermined number has been repeated (see step S7). Note that the operations in steps S32a and S32b are described as separate operations, but the operations in steps S32a and S32b can be carried out by one operation based on the ALLREDUCE instruction. Similarly, the operations in steps S42a and S42b are described as separate operations, but the operations in steps S42a and S42b may be carried out by one operation based on the ALLREDUCE instruction.

As described above, the communication process At paired with the differential process Ad receives the differential values calculated by the other differential processes Bd, Cd, . . . independently of whether the corresponding differential process Ad has completed calculation of the transmission value VA. This configuration enables the weight W to be updated each time the communication process At issues the ALLREDUCE instruction.

Although the time required for the differential process Ad to perform the first cycle is longer than the time required for the communication process At to perform the second cycle, it is possible to learn each weight W of the CNN by the processing speed of the communication process At independently of the processing speed of the differential process Ad.

FIG. 7 is a timing chart schematically illustrating how the differential processes and the communication processes operate. FIG. 7 illustrates, as an example, that six differential processes Ad to Fd each perform the routine illustrated in FIG. 5. A proper number of the differential processes will be described later. In FIG. 7, the tip end of each arrow represents the time at which a corresponding differential process has just completed calculation of the corresponding transmission value. For example, the differential process Cd has just completed calculation of the corresponding transmission value at each of time t1, time t3, and time t5.

The time, referred to as first-cycle time, required for each differential processes Ad to Fd to perform the first cycle, in other words, the time required for each differential processes Ad to Fd to complete calculation of the corresponding transmission value, cannot be set to the same time. That is, the first-cycle times can be set to be different from each other depending on the performances of the corresponding nodes. The first-cycle times can also be set to be different from each other depending on the difference between the pieces of training data read by each differential process and the pieces of training data read by another differential process.

For example, the differential process Ad is higher in processing speed than the differential process Bd. The differential process Ed has different periods, each of which is required to calculate the transmission value. One of the different periods is the longer period from the time t2 to the time t4, and the other is the shorter period from the time t4 to the time t5.

On the other hand, each of the six communication processes At to Ft periodically issues the ALLREDUCE instruction. In FIG. 7, the ALLREDUCE instructions are therefore issued at the respective times t1 to t5.

For example, at the time t1, because the differential processes Ad, Cd, and Dd have already completed the transmission values, each of the corresponding communication processes At, Ct, and Dt transmits the variables Array1 to the communication processes At to Ft (see step S32a of FIG. 6). In contrast, at the time t1, because the differential processes Bd, Ed, and Fd have not completed the transmission values yet, each of the corresponding communication processes Bt, Et, and Ft transmits the variables Array2 to the communication processes At to Ft (see step S42a of FIG. 6).

The variables Array1 transmitted by the respective communication processes At, Ct, and Dt, which are based on the expressions (7), and the variables Array2 transmitted by the respective communication processes Bt, Et, and Ft, which are based on the expressions (9), are represented by the following expressions:

Array1(At)=[W1−r*dWA1,−r*dWA2,−r*dWA3,−r*dWA4,−r*dWA5,−r*dWA6]

Array2(Bt)=[0,W2,0,0,0,0]

Array1(Ct)=[−r*dWC1,−r*dWC2,W3−r*dWC3,−r*dWC4,−r*dWC5,−r*dWC6]

Array1(Dt)=[−r*dWD1,−r*dWD2,−r*dWD3,W4−r*dWD4,−r*dWD5,−r*dWD6]

Array2(Et)=[0,0,0,0,W5,0]

Array2(Ft)=[0,0,0,0,0,W6]

These variables Array1(At), Array(Bt), Array(Ct), Array(Dt), Array(Et), and Array(Ft) are added to each other based on the ALLREDUCE instruction (see step S32b), so that the variable Array1 of the communication process At is represented by the following expression (11):

Array1(At)=[W1−r(dWA1+dWC1+dWD1,W2−r(dWA2+dWC2+dWD2 W3−r(dWA3+dWC3+dWD3,W4−r(dWA4+dWC4+dWD4,W5−r(dWA5+dWC5+dWD5,W6−r(dWA6+dWC6+dWD6)] (11)

This is equivalent to the expressions (9) when the training data read by the differential processes Ad, Cd, and Dd is used.

The variable Array1 of the communication process Ct and the variable Array1 of the communication process Dt based on the ALLREDUCE instruction are obviously identical to the variable Array1 of the communication process At. Similarly, the variable Array2 of the communication process Bt, the variable Array2 of the communication process Et, and the variable Array2 of the communication process Ft based on the ALLREDUCE instruction are obviously identical to the variable Array1 of the communication process At.

This results in the weights W of the differential processes Bd, Ed, and Fd being updated at the time t1 although the differential processes Bd, Ed, and Fd have not completed calculation of the transmission values. At each of the times t2 to t5, because some of the differential processes have completed calculation of the transmission values, the weights W of the remaining differential processes, which have not completed the transmission values, are updated based on the calculated transmission values.

The number of the differential processes can be determined as follows.

There is a condition that each differential process is configured to read A pieces of the training data; A is a predetermined integer equal to or more than 1, and the proper mini-batch size is previously determined to be B; B is a predetermined integer more than A. On the condition, the number of differential processes is adjusted such that an average of B/A differential processes have completed calculation of the transmission values each time the ALLREDUCE instruction is issued, i.e. each time the communication process At is about to perform the transmission.

As an easy example, each differential process reads ten pieces of the training data, and the proper mini-batch size is set to 100. An average of the differential processes have completed calculation of the transmission values for a time that is five times the period of issuing the ALLREDUCE instruction. In this example, fifty differential processes should be provided.

This enables an average of ten, which is obtained by 50/5, differential processes to have completed calculation of the transmission values each time the ALLREDUCE instruction is issued. Because ten pieces of the training data are used for calculation of each transmission value, the total of 100, which is obtained by 10×10, pieces of training data, that is, the proper mini-batch size of training data is used for one weight update of the CNN.

Note that it is well known that the mini-batch size can be set to be within a predetermined range. An average 100 pieces of training data every predetermined times of the issuance of the ALLREDUCE instructions can therefore have completed calculation of the transmission values.

The above learning method according to the first embodiment enables the learning speed to be independent from a time required for the differential processes to calculate the transmission values. This is because the learning of the weights W of the CNN can be carried out as long as at least part of all the differential processes have completed calculation of the transmission values. In particular, even if the differential processes include some differential processes lower in processing speed than the remaining differential processes, it is possible to maintain the learning speed of the weights W of the CNN unchanged independently of the lower processing speed differential processes. This therefore solves the first problem of the comparison example.

Even if the processing speed of each differential process is relatively low, for example, even if the processing programs of each differential process are not optimized or outdated nodes are used as the nodes 1, increasing the number of nodes 1 to increase the number of differential processes enables the learning of the weights W of the CNN to be accelerated. Even if the processing speed of each differential process is relatively low, the increased number of differential processes enables at least one of the differential processes to have completed calculation of the transmission value each time the ALLREDUCE instruction is issued. This therefore solves the third problem of the comparison example.

As described above, the learning system 100 is configured such that the differential programs are separated from the communication programs in each node 1, and each communication program issues the ALLREDUCE instruction without waiting for completion of the operations of the differential processes. This therefore reduces the time required for the learning system 100 to learn the parameters, such as the weights W, of the CNN, enabling the parameters to be completely learning within a realistically allowable time length.

### Second Embodiment

The following describes the learning system according to the second embodiment. The structures and/or functions of the learning system according to the second embodiment are different from those of the learning system 100 according to the first embodiment mainly by the following points. So, the following mainly describes the different points, and omits or simplifies descriptions of like parts between the first and second embodiments, to which identical or like reference characters are assigned, thus eliminating redundant descriptions.

Referring to FIG. 1, the CNN normally includes many filters 21a. Some of the filters 21a have similar structures from each other.

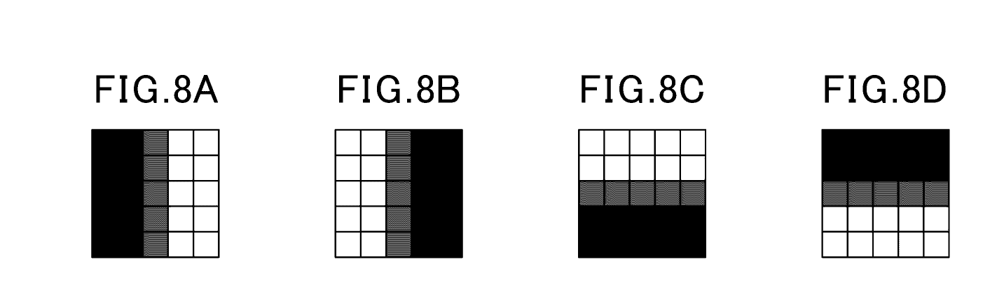

FIG. 8A to 8D illustrate respective typical filters each having a predetermined size of 5×5 pixels. The filter illustrated in FIG. 8A is a filter that weights a left vertical edge thereof, and the filter illustrated in FIG. 8B is a filter that weights a right vertical edge thereof. The filter illustrated in FIG. 8C is a filter that weights a bottom horizontal edge thereof, and the filter illustrated in FIG. 8D is a filter that weights a top horizontal edge thereof. These similar filters, some of which do not entirely agree with each other, are included in the same layer or different layers in the CNN. As seen by the fact that mammalian visual mechanisms have the same functions as these edge filters, information of edges of an image have great importance for image recognition.

In view of the circumstances, the second embodiment causes some filters, which are similar to each other, in all the original filters to be communalized as a common filter, so that the second embodiment is configured to learn the weights W of the reduced number of filters without performing individual learning of the weights W of all the original filters. This reduces the number of weights W to be learned, thus reducing the learning time.

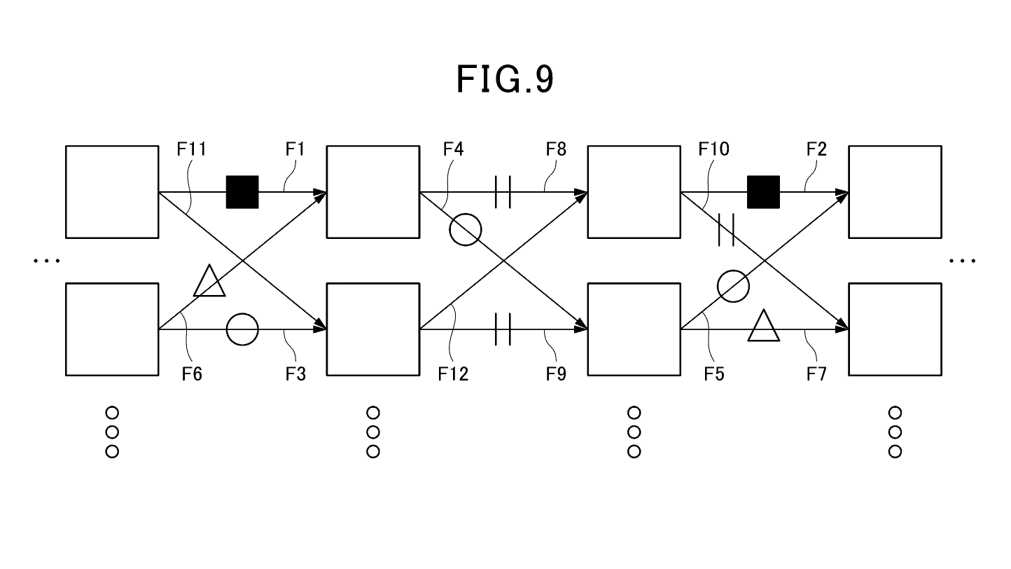

FIG. 9 is a schematic diagram schematically illustrating filter sharing. In FIG. 9, white outlined square blocks represent image signals, and arrows represent filters. That is, FIG. 9 represents convolution of each image signal using filters to output a new, i.e. convolved, image. Note that, as illustrated in FIG. 1, pooling is carried out after the convolution operations, but pooling is eliminated from illustration in FIG. 9.

In FIG. 9, filters, to which the same symbols, i.e. black squares, circles, or triangles, are assigned, are identical filters having the same weights W, the same initial value, and the same updated amount based on learning. In contrast, filters, to which no symbols are assigned, are independent filters, so that the weights of each of the independent filters are independently learned.

FIG. 9 illustrates twelve filters in total. The filters F1 and F2 with the black symbols are communalized to a shared filter, and the filters F3, F4, and F5 with the circular symbols are communalized to a shared filter. Additionally, the filters F7 and F8 with the triangle symbols are communalized to a shared filter, and the filters F8, F9, and F10 with the two vertical bar-shaped symbols are communalized to a shared filter.

That is, although the twelve filters F1 to F12 are provided in FIG. 9, six filters F1, F3, F7, F8, F11, and F12 should be actually learned.

It is necessary to determine filters to be shared before execution of learning. For example, allocating a common filter to selected filters in all filters of a target CNN is carried out based on random numbers.

The following describes a specific example of allocating a common filter to selected filters in all filters of the target CNN based on random numbers.

First, the structure of the target CNN is determined. Next, filers to be shared are prepared as free filters. A weight of each pixel through each of the free filters is initialized based on random numbers. The number of the free filters is set to M where M is an integer equal to or more than 2, and less than the number of filters of the target CNN. One of the M free filters is randomly sampled with replacement to be allocated to each filter of the target CNN. This completes the allocating of the shared filters to the target CNN.

Random sampling without replacement for a target filter, which is not shared thereto, can be carried out. This prevents the target filter from being shared to the other filters. If one or more the prepared filters are not allocated to filters of the target CNN, they should be eliminated. This eliminated filters are not used for the learning of the target CNN.

Filters, which are perfectly identical to each other, are not only shared as a shared filter, but filters, which have a predetermined relationship with each other, can also be shared as a shared filter. In other words, filters, one of which can generate another one of the filters, can be defined as a shared filter, i.e. a common filter.

For example, filters, one of which is rotated by a predetermined angle, such as 90 degrees, 180 degrees, or 270 degrees, to generate another one of the filters, can be defined as a common filter. Filters, one of which is symmetrically converted with respect to a point to generate another one of the filters, can be defined as a common filter. Filters, one of which is horizontally or vertically reversed to generate another one of the filters, can be defined as a common filter. For example, in FIG. 9, when the filters F6 and F7 to which the triangle symbols are assigned are obtained by rotating, by 90 degrees, one of the filters F3, F4, and F5 to which the circular symbol is assigned, the filters F6 and F7 can belong to the common filters F3 to F5. This results in reduction of the weights W that need to be learned.

FIG. 9 illustrates some filters are defined as a shared filter, but some synapses, i.e. some connections, between nodes can be defined as a common synapse, i.e. a common connection.

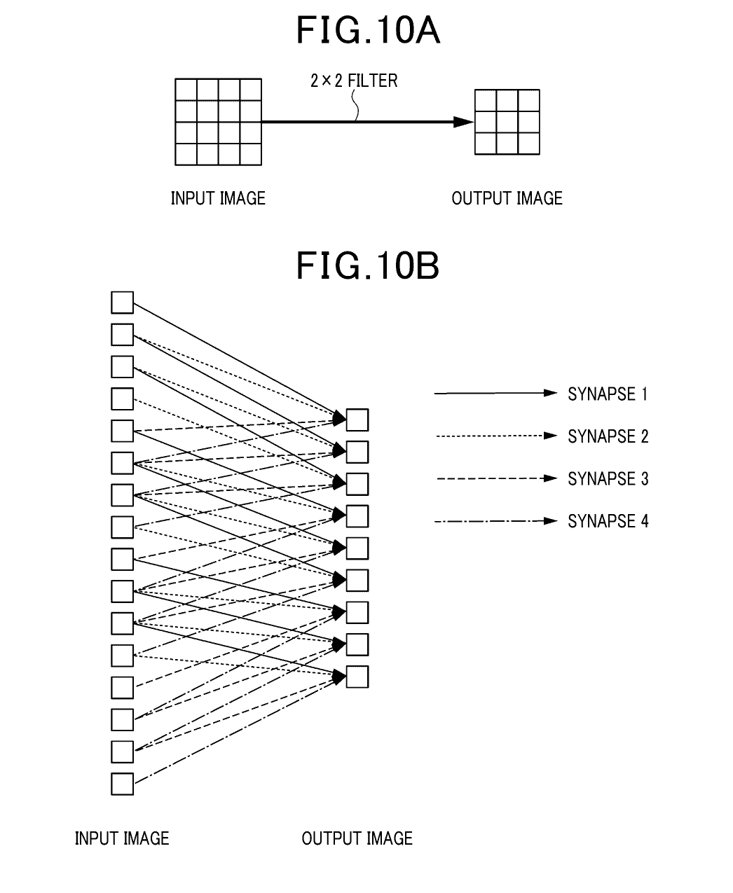

FIG. 10A schematically illustrates an image signal, i.e. an input image, having 4×4 pixels is filtered by a filter having 2×2 pixels, so that a new image signal, i.e. an output image, is generated. Dividing each of the input image and output image into pixels and developing the divided pixels of the input image and divided pixels of the output image with synapses, i.e connections, therebetween obtain FIG. 10B. FIG. 10B is a part of the network diagram showing the synapses. Each synapse has a weight. Because the network diagram illustrated in FIG. 10A uses the filter having 2×2 pixels, there are four individual synapses SYNAPSE 1, SYNAPSE 2, SYNAPSE 3, and SYNAPSE 4 respectively illustrated by solid lines, dashed short dashed lines, long dashed lines, and dot-and-dash lines.

If a plurality of synapses having the same weight are used in a feature map, this situation is called weight sharing in the feature map. Weight sharing has a shift invariance effect and an effect of preventing the increase of the number of the parameters, i.e. the weights, that is, an effect of preventing the occurrence of overlearning.

When convolutions, i.e. product-sum operations, included in all the layers of the CNN including the convolution units 21 and the multilayer neural network structure 23 are developed to clearly demonstrate all the synapses between nodes (units) in the CNN as illustrated in FIG. 10B, freely selected synapses, which are not filters, in all the synapses can be shared as a shared synapse. This reduces the degree of freedom of the selected synapses. The class of weights whose synapses have reduced degree of freedom are called free weights. Sampling with replacement or sampling without replacement can be used to allocate such free weights to the CNN.

Synapses, whose weights are perfectly identical to each other, are not only shared as a shared synapse, but synapses, whose weights have a predetermined relationship with each other, can also be shared as a shared synapse. In other words, synapses, one of which has a weight that can calculate a weight of another one of the synapses, can be defined as a shared synapse, i.e. a common synapse.

For example, a synapse, which has a weight Wa, and a synapse, which has a weight Wb, are defined as a shared synapse when the weight Wa and the weight Wb have a predetermined functional equation, such as the equation Wa=3Wb+2. This results in an increase of the number of the free weights, thus resulting in further reduction of the weights that should be learned.

As described in the first embodiment, when the learning of the weights of the CNN is carried out based on the differential processes and the communication processes separated from the differential processes, adjusting the number of the free filters and/or free weights enables the learning speed to be adjusted while maintaining the structure of the CNN unchanged. Reconstructing the CNN requires many implementing steps, but adjusting the number of the free weights, i.e. shared weights, and/or the free filters, i.e. shared filters, requires only filter allocation and/or weight allocation before the learning set forth above. That is, the adjusting step is very simpler than the reconstructing step.

The number of parameters, i.e. weights, of the CNN determines the communication speed of the learning, and the communication speed determines the time required to perform the learning. Adjusting the number of the parameters, i.e. weights, of the CNN enables the time required to complete the learning to be controlled.

Specifically, firstly the number of the free weights of a corrected CNN are set to be (1/α) times the number of the free weights of an original CNN; a satisfies the equation 0<α<1. Secondly the number of the differential processes and the communication processes of the corrected CNN are set to be a times the number of the differential processes and the communication processes of the original CNN. These first and second settings enable the learning speed of the corrected CNN to be a times the learning speed of the original CNN even if the structure of the corrected CNN is identical to the structure of the original CNN. These first and second settings also enable the mini-batch size to be kept unchanged.

Even if the number of the weights W increase with an increase of the structure of the CNN, adjusting the number of the free weights in the CNN prevents an increase of the learning time. This therefore solves the second problem of the comparison example.

### Third Embodiment

The following describes the learning system according to the third embodiment. The structures and/or functions of the learning system according to the third embodiment are different from those of the learning system 100 according to the first embodiment mainly by the following points. So, the following mainly describes the different points, and omits or simplifies descriptions of like parts between the first and third embodiments, to which identical or like reference characters are assigned, thus eliminating redundant descriptions.

The third embodiment is configured such that each differential process encodes the corresponding differential value to compress it, and the corresponding communication process transmits the transmission value based on the compressed differential value to the other communication processes. This configuration reduces the communications traffic between the corresponding communication process and the other communication processes.

The following describes the concept for compressing the differential value.

Repeatedly learning and updating the weight of the CNN using stochastic gradient descendent enables the weights to gradually change so as to converge to corresponding local solutions. The transfer vectors of the weights while the weights are learned are at least partially associated with each other. Specifically, transition, i.e. change, of each weight is biased to a specific direction, and has a fluctuation component directed to be different from the specific direction.

The learning system according to the third embodiment is configured to extract a component of the transition of each weight in a main direction of the transition, and cause the extract component of the transition of each weight to communicate with the nodes. In other words, the differential components of the cost function of the CNN are separated between main components contributing to the transition of each weight in the main direction, and minor components, which do not contribute to the transition of each weight. Then, the learning system is configured to cause each communication process to only communicate with the other communication processes. This reduces the capacity of each node 1 required to store the communication processes, thus reducing the capacity for storing each of the communication variables to reduce the learning time while stably reducing the cost function of the weights (W) of the CNN.

The following describes in detail the learning method according to the third embodiment.

Encoding a vector δ using an encode function ENC obtains an encoded value, such as a vector or a matrix, δe in accordance with the following expression (12):

δe=ENC(δ,φe) (12)

Where φe represents a parameter used by the encoding, and described in detail later.

Causing the dimensions, i.e. the number of elements, of the encoded value δe to be lower than the dimensions, i.e. the number of elements, of the vector δ enables the vector δ to be compressed, thus reducing the data amount of the encoded value to be lower than the data amount of the vector δ.

Decoding a vector δ′ using a decode function DEC obtains a decoded value δd, which is represented by the following expression (13):

δd=DEC(δ′,φd) (13)

Where φd represents a parameter used by the decoding, and described in detail later.

To sum the encoded vectors based on the ALLREDUCE instruction, it is desired that the encode function ENC satisfies the distributive law represented by the following expression (14):

ENC(δ+λ,φe)=ENC(δ,φe)+ENC(λ,φe) (14)

Where λ represents an addition value to the vector δ.

In order to keep main information about weight updating, it is necessary to decode the encoded value δe to obtain the original vector δ accordingly. Specifically, the encode function ENC and the decode function DEC need satisfy the following expression (15):

δ≈DEC{ENC(δ,φe)+ENC(λ,φe)} (15)

Note that, for learning the weights of the CNN, the value obtained by decoding the encoded value δe can be slightly different from the original vector δ.

Properly determining the encode function ENC, decoded function DEC, and parameters φe and φd enables proper compression of the vector δ, which meets the expressions (14) and (15) to be carried out.

We describe specific examples of the respective encode function ENC, the decode function DEC, and the parameters φe and φd later. That is, the following mainly describes the different points between the set of the differential process Ad and the communication process A according to the third embodiment from the set of the differential process Ad and the communication process A according to the first embodiment assuming that the encode function ENC, decoded function DEC, and parameters φe and φd are determined to satisfy the expressions (14) and (15).

First, variables Flag and Array, which are transferable between the differential process Ad and the communication process At are defined.

Like the first embodiment, the variable Flag is a binary variable having 0 as its initial value. When the variable Flag is set to 0, the variable Flag represents that the differential process Ad has not completed calculation of the transmission value yet. When the variable Flag is set to 1, the variable Flag represents that the differential process Ad has completed calculation of the transmission value.

Let us define a difference value De, which is obtained by encoding the difference between a first value of the weight W at a first time and a second value of the weight W at a second time, which have been updated one or more times since the first time. In the variable Array, the difference value De is stored by the communication process At. The communication process At according to the third embodiment updates the weight W using the difference value De, and passes the updated weight W to the differential process Ad. That is, the communication process At according to the third embodiment also serves as a weight updating process.

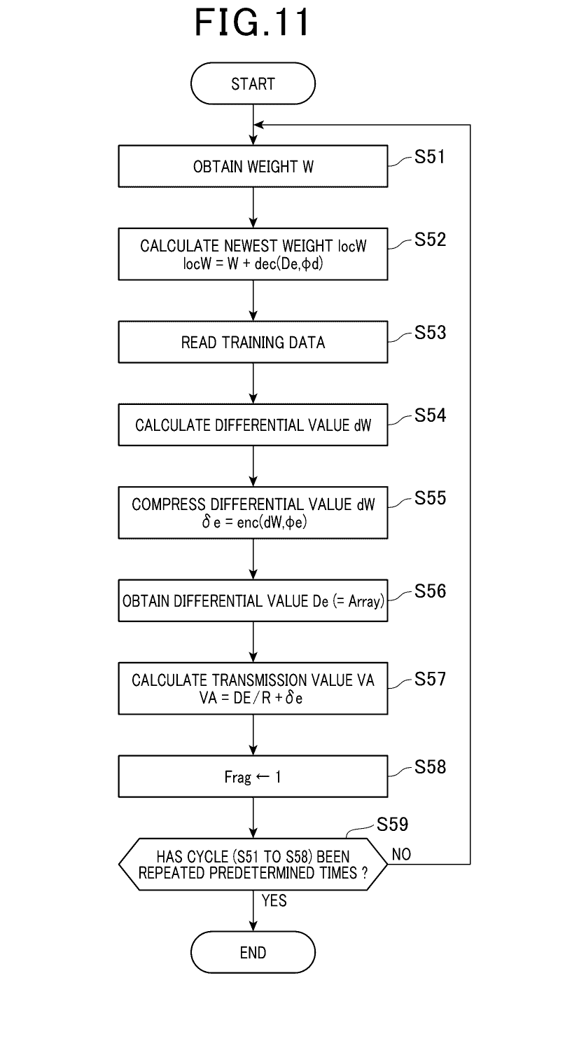

FIG. 11 is a flowchart schematically illustrating the operations carried out by the differential process Ad according to the third embodiment.

First, the differential process Ad obtains the weight W at a specified time from the communication process At in step S51. Next, the differential process Ad uses the weight W at the specified time and the difference value De to calculate a newest weight locW accordingly in step S52.

Note that, as described later, the following operations S51 to S58, and the differential process Ad is programmed to repeat a cycle comprised of the operations S51 to S58.

That is, the difference value De at the first time of execution of the cycle is zero as its initial value. The difference value De at the K-th time of execution of the cycle (K is an integer equal to or more than 2), the value obtained in step S56 described later in the (K−1)-th time of execution of the cycle is used.

Because the difference value De has been encoded, the difference value De need be decoded when used. Specifically, in step S52, the differential process Ad obtains the newest weight locW in accordance with the following expression (16):

locW=W+DEC(De,φd) (16)

Note that the newest weight locW is used by only the differential process Ad, so that the newest weight locW need not be communicated with the other differential processes.

Next, the differential process Ad reads predetermined pieces of training data stored in the storage 13 in step S53, and calculates the differential value dW based on the backpropagation using the pieces of training data in step S54.

Following the operation in step S54, the differential process Ad encodes the differential value dW in accordance with the following expression (17) to compress it, thus obtaining the encoded value δe in step S55:

δe=ENC(dW,φe) (17)

The differential process Ad obtains the difference value De from the variable Array of the communication process At in step S56. The difference value De obtained in step S56 is also used by step S52 in the next cycle of execution of the operations from S51 to S59.

Following the operation in step S56, the differential process Ad calculates the transmission value VA in accordance with the following expression (18):

VA=De/R+De (18)

Where R represents the total number of the differential processes.

When calculation of the transmission value VA is completed, the differential process Ad sets the variable Flag to 1 in step S58. Note that the variable Flag will be set to 0 again by the communication process At described later.

After completion of the operation in step S58, the differential process Ad determines, in step S59, whether the cycle of the operation from step S51 to the operation in step S58 has been repeated a predetermined number of times.

When determining that the cycle of the operation from step S51 to the operation in step S58 has not been repeated the predetermined number of times (NO in step S59), the differential process Ad returns to step S51, and repeatedly performs the operations in steps S51 to S59

Otherwise, when determining that the cycle of the operation from step S51 to the operation in step S58 has been repeated the predetermined number of times (YES in step S59), the differential process Ad terminates the routine illustrated in FIG. 11.

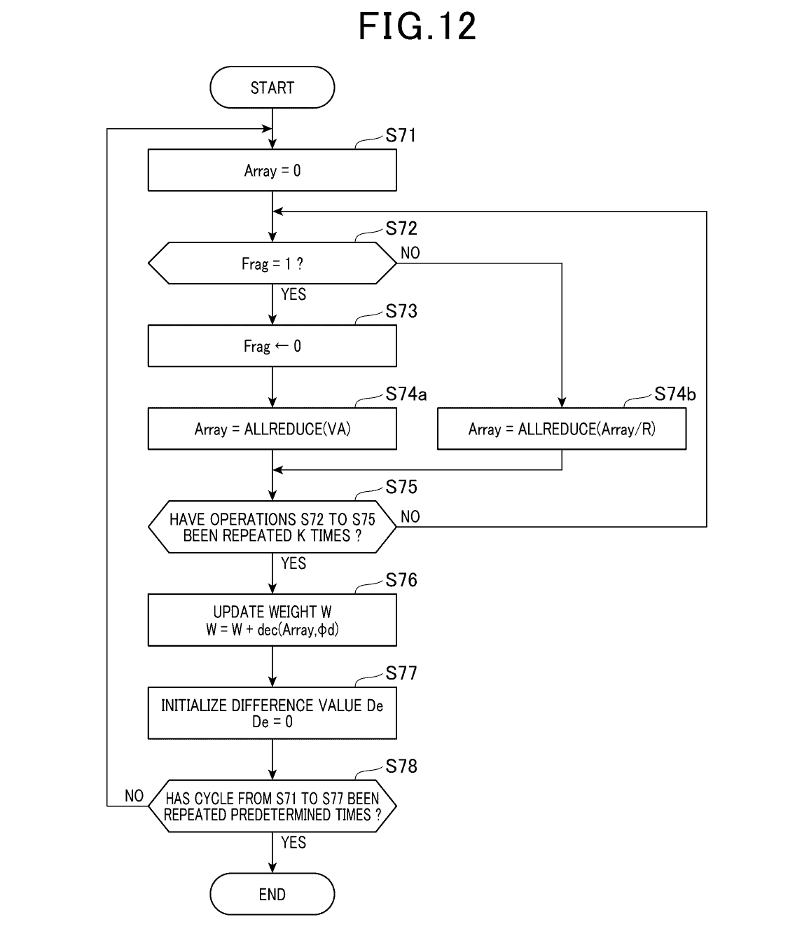

FIG. 12 is a flowchart schematically illustrating the operations carried out by the communication process At according to the third embodiment.

The communication process At periodically issues the ALLREDUCE instruction at least K times (K is equal to or more than 1) to store the differential values, and thereafter, updates the weight.

First, the communication process At sets the variable Array to an initial value of 0 in step S71. The communication process At periodically issues the ALLREDUCE instruction to transmit values to another communication process. The values transmitted by the ALLREDUCE instruction vary depending on a value of the variable Flag each time the ALLREDUCE instruction is issued.

Specifically, when issuing the ALLREDUCE instruction, the communication process At determines whether the variable Flag is 1 in step S72. When determining that the variable Flag is 1 (YES in step S72), the communication process At determines that the differential process Ad has completed the calculation of the transmission value VA. Then, the communication process At resets the variable Flag to 0 in step S73, and issues the ALLREDUCE instruction for the transmission value VA calculated by the differential process Ad in step S74a.

Specifically, the communication process At transmits the transmission value VA to the other communication processes Bt and Ct of the same node and to the other communication processes At to Ct of the other nodes Bt, Ct, Dt, . . . , and receives the transmission values from the other communication nodes Bt, Ct, Dt, . . . . Then, the communication process At calculates the sum of the transmitted transmission value VA and the transmission values sent from the other communication nodes, and stores the result of the summing operation to the variable Array.

Otherwise, when determining that the variable Flag is 0 (NO in step S72), that is, when the differential process Ad has not completed calculation of the transmission value VA, the communication process At issues the ALLREDUCE instruction for (1/R) of the current value, such as the difference value De, stored in the variable Array in step S74b. The (1/R) of the current value stored in the variable Array will be referred to as (Array/R) hereinafter.

Specifically, the communication process At transmits the value (Array/R) as the transmission value to the other communication processes Bt, Ct, Dt, . . . , and receives the transmission values from the other communication processes Bt, Ct, Dt, . . . . Then, the communication process At calculates the sum of the transmitted transmission value (Array/R) and the transmission values sent from the other communication nodes, and stores the result of the summing operation to the variable Array.

The communication process At repeats the operations from step S72 to S75 K times in step S75.

This enables K encoded values, each of which represents the sum of the differential value dW calculated by the differential process Ad and the differential values calculated by the other differential processes, to be accumulated in the variable Array. The accumulated value in the variable Array corresponds to the difference value between the weight W at the specified time and the weight after being updated K times.

The following describes, in detail, the reason why the accumulated value in the variable Array corresponds to the difference value between the weight W at the specified time and the weight after being updated K times.

As seen by steps S56 and S57 in FIG. 11 and step S74a in FIG. 12, at least one communication process, which is paired to at least one differential process that has completed calculation of the differential value, transmits the transmission value VA that is represented by the following expression (19):

VA=(De/R)+δe=(Array/R)+δe (19)

On the other hand, as seen by step S74b in FIG. 12, at least one communication process, which is paired to at least one differential process that has not completed calculation of the differential value, transmits the transmission value TV that is represented by the following expression (20):

TV=Array/R (20)

The ALLREDUCE instruction causes the transmission values transmitted from all the communication processes to be added to each other. Because the total number of the differential processes is R, the sum of the first term of the expression (19) and the expression (20), which are sent from all the communication processes, results in the current variable Array being obtained. Adding the second term of the expression (19), i.e. the differential value for updating the newest weight locW, to the current variable Array obtains a new variable Array.

When the ALLREDUCE instruction is carried out the first time (steps S74a, 74b), the differential value for updating, one time, the weight at the specified time is stored in the variables Array of all the communication processes. Note that these addition operations can be carried out, because the encode function ENC satisfies the distributive law.

When the ALLREDUCE instruction is carried out the second time, the differential value for further updating the updated weight, which is obtained by updating the weight at the specified time, is stored in the variables Array of all the communication processes. In other words, the differential value for updating, two times, the weight at the specified time is stored in the variables Array of all the communication processes. This means that, in each of the variables Array, the encoded value of the difference value De between the weight W at the specified time and the weight that have been updated two times is stored.

That is, when the ALLREDUCE instructions are carried out K times, the encoded value of the difference value De between the weight W at the specified time and the weight that have been updated K times is stored in each variable Array.

After the ALLREDUCE instructions are carried out K times, the communication process At updates the weight W in accordance with the following expression (21) in step S76:

W=W+DEC(Array,φd) (21)

In addition, the communication process At initializes the difference value De to zero in step S77.

After completion of the operation in step S77, the communication process At determines whether the cycle of the operation in step S71 to the operation in step S77 has been repeated a predetermined number of times in step S78.

When determining that the cycle of the operation in step S71 to the operation in step S77 has not been repeated the predetermined number of times (NO in step S78), the communication process At returns to step S71, and repeatedly performs the operations in steps S71 to S78

Otherwise, when determining that the cycle of the operation in step S71 to the operation in step S77 has been repeated the predetermined number of times (YES in step S78), the communication process At terminates the routine illustrated in FIG. 12.

As described above, the learning system according to the third embodiment is configured such that the encoded value δe, which is obtained by encoding the difference value between the weight W at a specified time and the K-times updated weight W, is communicated between the communication processes. This results in reduction of the communications traffic between the communication processes.

In particular, because the differential value and the difference value are encoded without the weight W being encoded, it is possible to prevent reduction of the expression ability of the CNN.

Next, the following describes in detail specific examples of the encode function ENC, decode function DEC, and the parameters φe and φd.

The encoding parameter δe is a matrix, and the encode function ENC is based on matric operations. Specifically, the encode function ENC in the expression (12) is defined as the following expression (12′):

δe=ENC(δ,φe)=φeδ (12′)

Where the vector δ corresponds to the differential value dW. The matrix φe serves to map the differential value dW for updating the weight W to a linear subspace, i.e. a low-dimensional space, of the differential value dW. The linear subspace, of course, should include the updating direction of the original weight W. If the linear subspace did not include the updating direction of the original weight W, the cost function of the CNN would not be reduced in spite of continuous learning of the CNN. Repeatedly updating of the weight W for a long time enables the updating direction of the weight W to be taken as a linear direction within a short time section, i.e. a short period of time. It is possible to therefore design a proper matrix δe based on a short time section in the total long updating time section.

Next, let us consider that the linear subspace is generated based on eigenvalue decomposition of a matrix defined by a differential value within a past short time section.

A column vector δⁱ comprised of all differential values used for the i-th weight updating is defined as a differential vector δⁱ. Actually, the differential processes dispersedly calculate the differential values. For this reason, for example, issuing the ALLREDUCE instruction for the differential values generated by the respective differential processes enables the differential values calculated from all the differential processes to couple to each other. This obtains the differential vector δⁱ comprised of all the differential values.

When the number of elements of the differential vector δⁱ is set to d, in other words, when the differential vector δⁱ is a matrix having three rows and one column, a square matrix D with d rows and d columns is defined in accordance with the following expression (22):

D=(δ^{i-d+},δ^{i-d+2}, . . . ,δⁱ) (22)

A matrix C, which is equal to DD^{T}, is subjected to eigenvalue decomposition, so that a matrix C, which is equal to VEV^{T} is obtained.

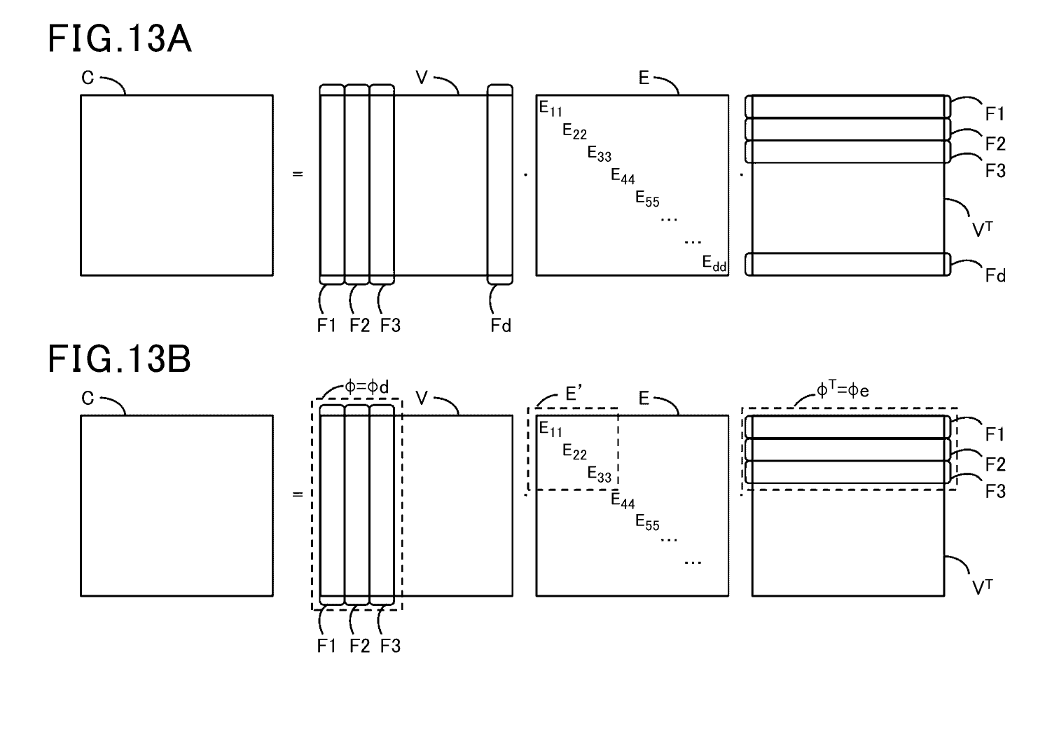

FIG. 13A is a diagram describing an example of the matrixes C, V, and E. Specifically, referring to FIG. 13A, the matrix E has, as its diagonal elements, eigenvalues E₁₁ to E_{dd} from top to bottom, and has, as its all off-diagonal elements, zero. The matrix V has, at its columns, eigenvectors F1 to Fd respectively corresponding to the eigenvalues E₁₁ to E_{dd}, and the matrix VV^{T} is a unit matrix. The matrix V^{T} is a transpose matrix of the matrix V.

p eigenvalues are selected from the eigenvalues E₁₁ to E_{dd} in order of decreasing value; p is lower than d. As an example, the lowest one of the values a that satisfy the equation E₁₁>100Eₐ₊₁ₐ₊₁ is set to the value p.

Because the selected eigenvalues E₁₁ to Eₚₚ each have a larger value, the selected eigenvalues E₁₁ to Eₚₚ have a larger impact on the matrix C. In contrast, because the non-selected eigenvalues Eₚ₊₁ₚ₊₁ to E_{dd} each have a smaller value, the non-selected eigenvalues Eₚ₊₁ₚ₊₁ to E_{dd} have a smaller impact on the matrix C.

For example, when p is set to 3, so that the eigenvalues E₁₁ to E₃₃ are selected from the eigenvalues E₁₁ to E_{dd}, the marked portion by the dashed square in each of the matrixes V, E, and V^{T} is important as illustrated in FIG. 13B. Thus, a square matrix with p columns and p rows is defined as a matrix E′. That is, the matrix E′ is a square matrix that has, as its diagonal elements, eigenvalues E₁₁ to E₃₃ from top to bottom, and has, as its all off-diagonal elements, zero. In addition, a matrix, which has d rows and q columns and is comprised of the eigenvectors F₁ to Fₚ, is defined as a matrix φ. At that time, the matrix C is approximated to the following expression (23):

C≈φE′φ^{T} (23)

The matrix φ^{T} represents the matrix δe used by the encode function ENC. Thus, the encoded value δeⁱ, which is obtained by encoding the differential vector δⁱ, is represented by the following expression (24):

δeⁱ=ENC(δⁱ,φe)=ENC(δⁱ,φ^{T})=φ^{T}δⁱ (24)

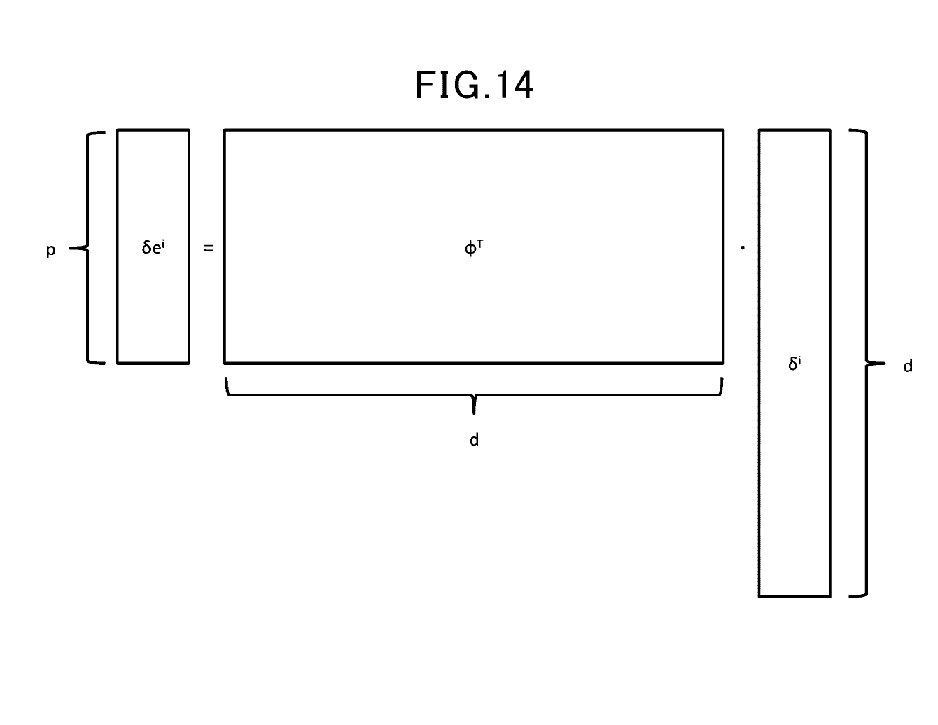

FIG. 14 is a diagram schematically illustrates the expression (24). The expression (24) shows that the encoded value δeⁱ is a matric, i.e. a vector, with p rows and one column. Specifically, this results in the differential vector δⁱ whose number of the elements is d being transformed to the encoded value δeⁱ whose number of the elements is p that is smaller than d. This results in the differential vector δⁱ being transformed to the lower-dimensional encoded value δeⁱ, thus compressing the differential vector δⁱ to the encoded value δeⁱ.

The matrix φ, which is obtained by transposing the transpose matrix φ^{T}, is defined as the decoding matrix φd. This enables execution of the following expressions (25) to reconstruct the original differential vector δⁱ before compression with high accuracy:

$$\begin{matrix}{δ}^{i} = DEC ( δ {e}^{i} , φ d ) \\ = DEC ( δ {e}^{i} , φ ) \\ = φδ {e}^{i} = φ ( {φ}^{T} {δ}^{i} ) = {δ}^{i}\end{matrix} \qquad ( 25 )$$

In accordance with the characteristics of the matrix operations, any differential vectors δ and λ satisfy the distributive law represented by the following expression (26):

φ^{T}(δ+λ)=φ^{T}δ+φ^{T}λ (26)

As described above, only using the p eigenvalues E₁₁ to Eₚₚ each have a larger value in the matrix E enables the differential vector δⁱ to be compressed to the encoded value δeⁱ. Because the eigenvalues Eₚ₊₁ₚ₊₁ to E_{dd} each have a smaller value, it is possible to return, i.e. restore, the encoded value δeⁱ to the original differential vector δⁱ with high accuracy.

Because the encode function ENC is based on matric operations, the encode function ENC satisfies the distributive law. Thus, decoding the sum of an encoded value of a differential vector δ and an encoded value of a differential vector λ enables the sum of the differential vector δ and the differential vector λ to be obtained, which is compatible with the ALLREDUCE instruction.

The above approach can be understood as a specific principal component analysis when the matrix D is a data matrix. The difference between the specific principal component analysis and normal principal component analysis is that the normal principal component analysis uses, in place of the matric D, a matrix, which is obtained by subtracting, from each column of the matrix D, an average vector of all the column vectors. This approach, which does not perform the subtraction, can be regarded as principal component analysis in a broad sense.

Because the CNN actually includes many weights W, the number d of elements of the differential vector δⁱ becomes large. In this case, the eigenvalue decomposition of the matrix C to obtain the matrix V may take time. This may cause the time required for the eigenvalue decomposition to be longer than the time required for differential-value calculation. To address the circumstances, it is desirable to use a predetermined folding function RESHAPE, described in detail later, to transform the differential vector δⁱ into a differential-value matrix δⁱ′ with q rows smaller than the number of elements, i.e. the number of rows, of the differential vector δⁱ in accordance with the following expression (27):

δⁱ′=RESHAPE(δⁱ,q,r) (27)

Where r represents the number of columns of the differential-value matrix δⁱ′, which depends on the value d/q.

The number q of rows is determined such that the time required for eigenvalue decomposition of a matrix with q rows and q columns has a low order than the time required for differential-value calculation.

In this case, substituting the differential vector δⁱ into the differential-value matrix δⁱ′ in the above description enables the matrixes φe and φd to be obtained.

Specifically, a matrix D′ is defined in accordance with the following expression (22′) in place of the square matrix with d rows and d columns represented by the equation (22′):

D′=(δ^{i-b+1′},δ^{i-b+2′}, . . . ,δ^{i′}) (22)

Where b represents how many past differential-values to be used. That is, b is determined such that the number of columns of the matrix D′ is larger than the number of rows of the matrix D′ in order to prevent rank deficient of the matrix C=D′D′^{T}. Thereafter, the procedure to obtain the matrix φe=φ^{T}, φd=φ is the same as the above procedure.

In this case, the expression (24) is represented by the following expression (24′):

δeⁱ=ENC(δ^{i′},φe)=φ^{T}δ^{i′} (24′)

The matrix φ^{T} has p rows and q columns. Because the differential-value matrix δ^{i′} has q rows and r columns, the encoded value δeⁱ has p rows and r columns. Because q>p, this results in the encoded value δeⁱ to be transformed to the lower-dimensional differential-value matrix δ^{i′}. Note that, if a matrix need be transformed into a column vector, sorting the elements of the matrix enables the column vector to be obtained.

The following describes the folding function RESHAPE. The folding function RESHAPE serves to sort the elements of a target matrix to transform the size of the target matrix. For example, an example of the transforming function of the folding function RESHAPE is represented by the following expression (28):

$$RESHAPE \{ ( \begin{matrix}1 & 4 & 7 & 10 \\ 2 & 5 & 8 & 11 \\ 3 & 6 & 9 & 12\end{matrix} ) , 2 , 6 \} = ( \begin{matrix}1 & 3 & 5 & 7 & 9 & 11 \\ 2 & 4 & 6 & 8 & 10 & 12\end{matrix} ) \qquad ( 28 )$$

In the expression (28), the first argument of the folding function RESHAPE represents the target matrix to be transformed, and the second and third arguments respectively represent the number of rows and the number of columns of a transformed matrix. Thus, the product of the second argument and the third argument should be equal to the number of elements of the target matrix. The second and third arguments can be omitted.

That is, If the second and third arguments are contextually obvious, the descriptions of the second and third arguments can be omitted. For example, the following expression (29) is satisfied:

$$( \begin{matrix}1 & 3 \\ 2 & 4\end{matrix} ) RESHAPE \{ ( \begin{matrix}1 & 4 & 7 & 10 \\ 2 & 5 & 8 & 11 \\ 3 & 6 & 9 & 12\end{matrix} ) \} = ( \begin{matrix}1 & 3 \\ 2 & 4\end{matrix} ) ( \begin{matrix}1 & 3 & 5 & 7 & 9 & 11 \\ 2 & 4 & 6 & 8 & 10 & 12\end{matrix} ) \qquad ( 29 )$$

Specifically, when the (2×2) matrix is multiplied by the output matrix of the folding function RESHAPE, the number of rows of the output matrix of the folding function RESHAPE should be 2, so that the second argument of the folding function RESHAPE is obviously 2. The number of elements of the target matrix to be transformed obviously leads to the conclusion that the third argument of the folding function RESHAPE is obviously 6. This therefore enables the second and third arguments of the folding function RESHAPE to be eliminated. As another example, the following equation (30) is satisfied:

$$( \begin{matrix}1 & 3 \\ 2 & 4\end{matrix} ) RESHAPE ( \begin{matrix}1 \\ 2 \\ 3 \\ 4 \\ 5 \\ 6 \\ 7 \\ 8 \\ 9 \\ 10 \\ 11 \\ 12\end{matrix} ) = ( \begin{matrix}1 & 3 \\ 2 & 4\end{matrix} ) ( \begin{matrix}1 & 3 & 5 & 7 & 9 & 11 \\ 2 & 4 & 6 & 8 & 10 & 12\end{matrix} ) \qquad ( 30 )$$

This equation (30) also makes obvious that the second and third arguments of the folding function RESHAPE are respectively 2 and 6.

If the description of the third argument of the folding function RESHAPE is omitted, and the second argument is a factor of the number of elements of the target matrix to be transformed, dividing the number of elements of the target matrix by the second argument obtains a value set to the third argument. For example, the following expression (31) is satisfied:

$$RESHAPE \{ ( \begin{matrix}1 & 4 & 7 & 10 \\ 2 & 5 & 8 & 11 \\ 3 & 6 & 9 & 12\end{matrix} ) , 2 \} = RESHAPE \{ ( \begin{matrix}1 & 3 & 5 & 7 & 9 & 11 \\ 2 & 4 & 6 & 8 & 10 & 12\end{matrix} ) , 2 , 6 \} \qquad ( 31 )$$

As a specific example, if the description of the third argument of the folding function RESHAPE is omitted, and the second argument is not a factor of the number of elements of the target matrix to be transformed, it is to insert 0 into indefinite elements of the output matrix. The number of 0 to be inserted is set to a minimum number. For example, the following equation (32) is satisfied:

$$RESHAPE \{ ( \begin{matrix}1 & 4 & 7 \\ 2 & 5 & 8 \\ 3 & 6 & 9\end{matrix} ) , 2 \} = RESHAPE ( \begin{matrix}1 & 3 & 5 & 7 & 9 \\ 2 & 4 & 6 & 8 & 0\end{matrix} ) \qquad ( 32 )$$

As another specific example, if the description of the second and third arguments of the folding function RESHAPE are omitted, and the second argument, which is contextually obvious, is not a factor of the number of elements of the target matrix to be transformed, it is to insert 0 into indefinite elements of the output matrix. The number of 0 to be inserted is set to a minimum number. For example, the following equation (33) is satisfied:

$$( \begin{matrix}1 & 3 \\ 2 & 4\end{matrix} ) RESHAPE \{ ( \begin{matrix}1 & 4 & 7 \\ 2 & 5 & 8 \\ 3 & 6 & 9\end{matrix} ) \} = ( \begin{matrix}1 & 3 \\ 2 & 4\end{matrix} ) ( \begin{matrix}1 & 3 & 5 & 7 & 9 \\ 2 & 4 & 6 & 8 & 0\end{matrix} ) \qquad ( 33 )$$

As described above, if the number of elements of the differential vector δⁱ is large, it is possible to use the folding function RESHAPE to transform the differential vector δⁱ into the differential-value matrix δⁱ′. This results in reduction of the time required for eigenvalue decomposition of the matrix C.

### Fourth Embodiment

The following describes the learning system according to the fourth embodiment. The structures and/or functions of the learning system according to the fourth embodiment are different from those of the learning system 100 according to the third embodiment mainly by the following points. So, the following mainly describes the different points, and omits or simplifies descriptions of like parts between the third and fourth embodiments, to which identical or like reference characters are assigned, thus eliminating redundant descriptions.

The encoding matrixes φe and φd are effective in a short time section. For updating in a short time section, the updating direction of the weight is substantially a linear direction, and the eigenvectors F1 to Fp correlate strongly with the differential vector δⁱ or the differential-value matrix δ^{i′}. For example, in the above descriptions, the differential vectors δ^{i-d+1} to δⁱ, which are respectively comprised of the differential values respectively used for the (i−d+1)-th updating to the i-th updating for a current short time section, are used to calculate the matrix φe. The future one or more updating operations after the i-th updating operation, it is possible to use the matrix φe as long as the future one or more updating operations can be taken within the current short time section.

However, the updating direction in a first short time section and the updating direction in a second short time section separated from the first short time section can be greatly different from each other. Specifically, even if the matrix φe is designed to include many updating directions within a current short time section, repeating of updating operations after the current short time section may cause the subspace based on the matrix φe to drift from the subspace in which the weight moves.

An increase of the drift may cause the eigenvectors F1 to Fp to be likely perpendicular to the differential vector δⁱ or the differential-value matrix δⁱ′. As seen by the expression (24) or (24′), this may cause each element of the encoded value δeⁱ to become close to zero, making it difficult to update the weights.

It is therefore desirable to reset the matrix φe at a proper timing to reduce the drift.

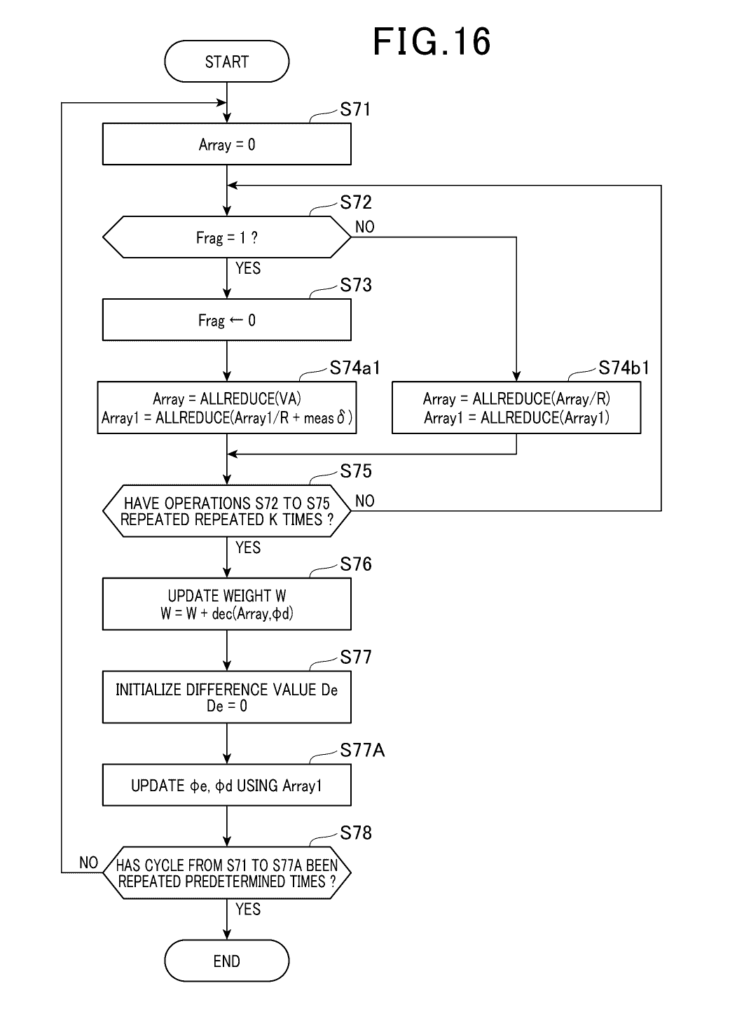

Specifically, the matrix φe can be updated only after the weights W have been updated predetermined times, such as K times illustrated in FIG. 16 described later. Alternatively, the matrix φe can be updated when the absolute value of each element of the encoded value δeⁱ calculated in the expression (24), which is calculated as δe in step S55 of FIG. 11, becomes close to zero.

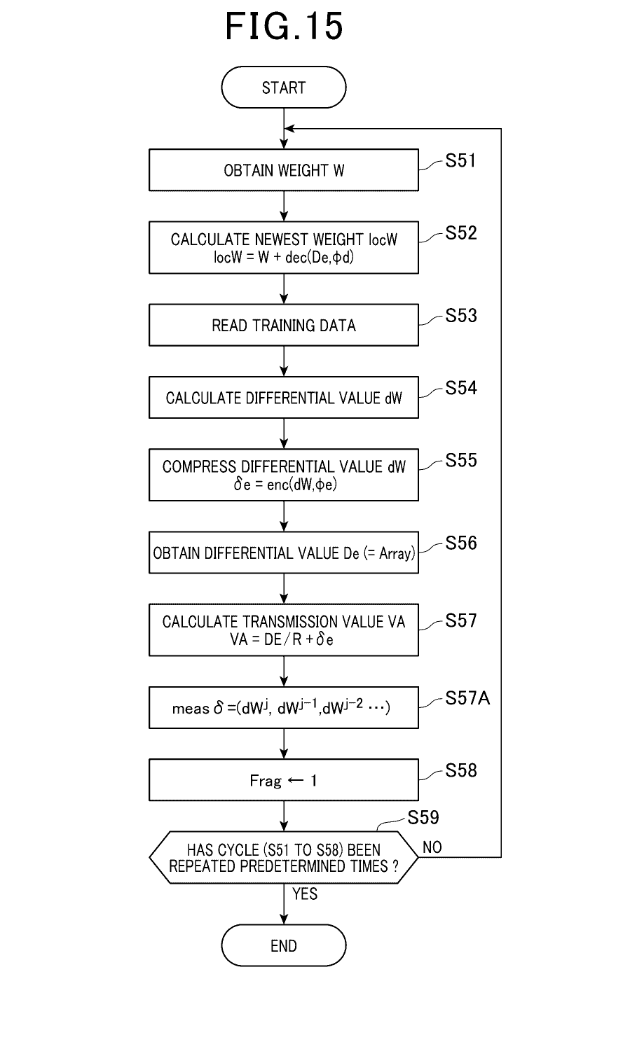

For updating the matrix φe at the timing of the i-th weight updating, the differential vectors δ^{i-d+1} to δⁱ used for the past d-times updating are required. The following therefore describes the operations carried out by the differential process Ad and the operations carried out by the communication process At according to the fourth embodiment with reference to FIGS. 15 and 16.

FIG. 15 is a flowchart schematically illustrating the operations carried out by the differential process Ad according to the fourth embodiment.

Note that, in FIGS. 11 and 15, like steps between the flowchart of FIG. 11 and the flowchart of FIG. 15, to which like step numbers are assigned, are omitted or simplified in description to avoid redundant description.

The operations in steps S51 to S57 illustrated in FIG. 15 are identical to respective steps S51 to S57 illustrated in FIG. 11. In particular, the differential process Ad calculates the transmission value VA in step S57, and calculates a statistical indicator meansδ in step S57A.

The statistical indicator meansδ includes the differential value dW^{j} calculated in the current cycle, i.e. the current loop, which is represented as the j-th cycle, the differential value dW^{j-1} calculated in the (j−1)-th cycle, the differential value dW^{j-2} calculated in the (j−2)-th cycle, . . . , and the differential value dW¹ calculated in the first cycle. The number of differential values included in the statistical indicator meansδ is defined depending on d in the equation (22) and/or depending on b in the equation (22).

FIG. 16 is a flowchart schematically illustrating the operations carried out by the communication process At according to the fourth embodiment.

Note that, in FIGS. 12 and 16, like steps between the flowchart of FIG. 12 and the flowchart of FIG. 16, to which like step numbers are assigned, are omitted or simplified in description to avoid redundant description.

The communication process At uses the Array1 for updating the matrixes φe and φd. Note that the communication process At actually can perform the routine illustrated in FIG. 16 using a variable as the combination of the variable Array and the variable Array1.

After the operation in step S73 when it is determined that the variable Flag is 1 (YES in step S72), the communication process At issues the ALLREDUCE instruction for the transmission value VA calculated by the differential process Ad, and issues the ALLREDUCE instruction for the variable (Array1/R+meansδ) in step S74a1.

Otherwise, when it is determined that the variable Flag is 0 (NO in step S72), the communication process At issues the ALLREDUCE instruction for the variable (Array/R), and issues the ALLREDUCE instruction for the variable (Array1/R) in step S74b1.

This enables the differential values dW^{j}, dW^{j-1}, . . . , dW¹ obtained by the differential process Ad and differential values obtained by the other differential processes to be stored in the variable Array1. This storing corresponds to obtaining the matrix D in each of the expressions (22) and (22′).

After issuance of the ALLREDUCE instructions K times, the communication process At uses the differential values stored in the variable Array1 to update the matrixes φe and φd in step S77A set forth above.

After completion of the operation in step S77A, the communication process At determines whether the cycle of the operation in step S71 to the operation in step S77A has repeated the predetermined number of times in step S78 set forth above.

The learning system according to the fourth embodiment is configured such that each differential process Ad encodes the corresponding differential value to transform the corresponding differential value to a lower-dimensional differential value. In addition, the learning system according to the fourth embodiment is configured such that each communication process At periodically updates the matrix φe used for the encoding. In particular, the learning system according to the fourth embodiment is configured such that each communication process At updates the matrix φe used for the encoding each time the ALLREDUCE instructions are generated K times.

This configuration enables the low-dimensional space to change with time, thus ensuring the substantially wide search space as the learning progresses.

In particular, each communication process At does not update the matrixes φe and φd each time the ALLREDUCE instruction is generated once, but updates the matrixes φe and φd each time the ALLREDUCE instructions are generated K times. This counters reduction of the processing speed. In learning of neural networks based on backpropagation, the change quantities in each weight for the respective K times issuances of the ALLREDUCE instructions, which are slightly different from each other, have some correlation with each other. Properly determining the value of the parameter K substantially maintains the recognition performance even if a stationary low-dimensional space is used while the ALLREDUCE instructions are generated K times.

### Fifth Embodiment

The following describes the fifth embodiment of the present disclosure.

The fifth embodiment includes a node for image processing independently from the nodes each performing the corresponding differential process and communication process. This aims to speed up the learning of a target neural network, such as a target CNN.

Recent research, such as image recognition research, frequently deforms images, and uses the deformed images as pieces of training data before calculating differential values for updating weights. The deformation means, for example, shifting the positions of images, converting the colors of the images, and rescaling the images. Image recognition systems learned using original images and deformed images as pieces of training data are capable of recognizing objects contained in various input images. Various deformations of each image obtain a variety of pieces of training data. This approach for artificially increasing pieces of training data will be referred to as data enhancement.

A first approach in the data enhancement increases the number of pieces of training data by n times before learning, and stores the increased number of pieces of training data in a storage. In this first approach, the differential process Ad of each node repeatedly reads pieces of training data, and calculates a differential value based on the read pieces of training data. Specifically, the learning system processes one piece of training data plural times, for example, 100 times.

A second approach in the data enhancement repeats the sequence of reading original images, randomly deforms the original images, and calculates differential values during learning process. This second approach is characterized by using random numbers to deform the original images. This prevents the second approach from repeatedly processing strictly identical images. This characteristic is effective in improving robustness of the learning system with respect to a variety of input images. The second approach discards images used for calculation of differential values. Previously preparing all deformed images might have difficulty due to the upper limit of the capacity of the storage.

Independently of the upper limit of the capacity of the storage, a required number of deformed images are generated and stored in the storage before execution of a learning task. Usually, such a learning task is repeatedly carried out while conditions are changed. Because the deformed images can be used again for at least some of the repeated learning tasks. For this reason, it is efficient to prepare deformed images before execution of the learning task.

It is impractical to prepare all deformed images before execution of the learning task due to the limited capacity of the storage. In view of the circumstances, there is an approach to perform image processing to generate deformed images each time the learning task is carried out. This approach however may result in the time required for calculating differential values extending by the image processing for each execution of the learning task. Consequently, this approach may require an increase of the number of nodes of the learning system if the mini-batch size is constant.

An increase of the number of nodes of the learning system may increase the time required for all the nodes to collectively communicate with each other. The main reason is that the larger the number of nodes is, the higher the possibility that one or more nodes, which have lower communication speeds, are included in all the nodes.

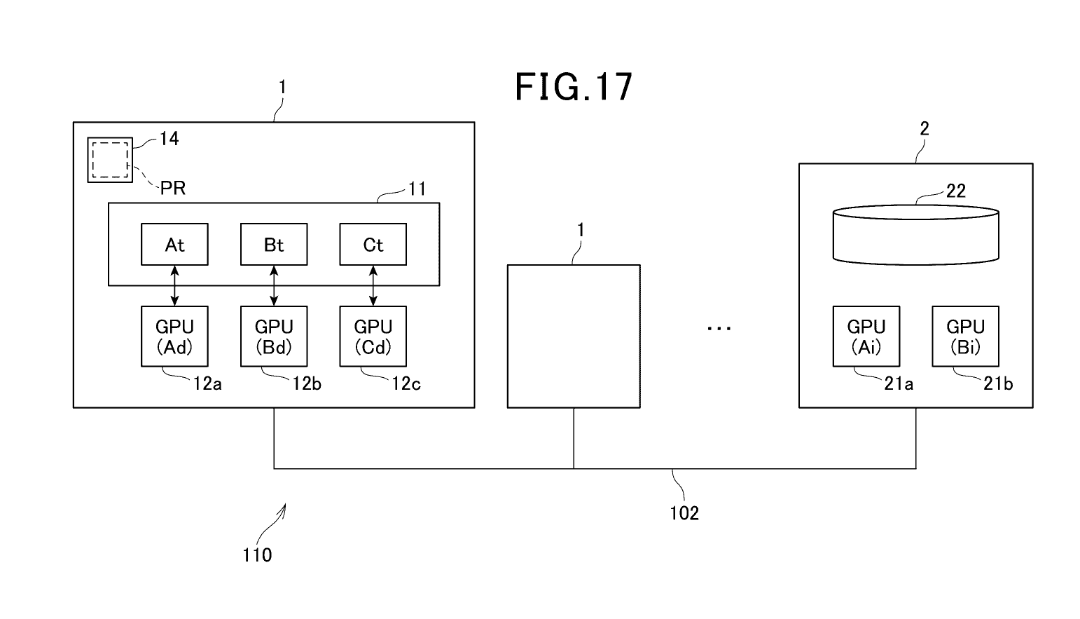

FIG. 17 is a block diagram schematically illustrating an example of the hardware structure of a learning system 110 according to the fifth embodiment.

The structures and/or functions of the learning system 110 illustrated in FIG. 17 are different from those of the learning system 100 illustrated in FIG. 4 mainly by the following points. So, the following mainly describes the different points, and omits or simplifies descriptions of like parts between the first and fifth embodiments, to which identical or like reference characters are assigned, thus eliminating redundant descriptions.

The learning system 110 is comprised of nodes 1 each for carrying out the corresponding differential processes and the corresponding communication processes like the first embodiment. The learning system 110 also includes at least one node 2 for performing image processing to deform images. The image-processing node 2 includes a GPU 21a for performing an image-processing task (process) Ai and a storage 22. The storage 22 can be designed as an external storage with respect to the corresponding node 2, so that the image-processing task Ai is accessible to the storage 22.

A plurality of images are stored in the storage for generating training data. If the at least one node 2 includes M nodes 2 where M is an integer equal to or more than 2, the images are divided by M, so that the divided images for each of the M nodes 2 are stored in the storage 22.

The image-processing task Ai obtains the images from the storage, and randomly deforms the images to generate deformed images that serve as pieces of training data. The image-processing task Ai can store the generated deformed images in the storage 22 or can store them in another storage, which can be installed in the node 2 or can be located at the outside of the node 2. The node 1 can include the MPI, and transfer the generated deformed images to the differential processes of each node 1 based on the MPI.

Note that how the image processing for randomly deforming images are implemented in the learning system 110 can be freely determined. For example, the image-processing node 2 can include a plurality of GPUs, such as GPUs 21a and 21b, and a plurality of image-processing tasks, such as image-processing tasks Ai and Bi, can be allocated for the respective GPUs 21a and 21b as illustrated in FIG. 17.

Each of the differential processes Ad, Bd, and Cd sequentially reads the deformed images, i.e. pieces of training data, from the storage 22, and calculates the corresponding differential value based on the deformed images. Each of the communication processes At, Bt, and Ct issues the ALLREDUCE instruction to communicate the transmission values including the differential values with the other communication processes, thus updating the corresponding weight W. This eliminates the need for each of the differential processes to perform deformation of images, making it possible to speed up the learning task.

Note that it is necessary that the rate, i.e. period, required for each image-processing task to generate a required number of deformed images is faster than the rate, i.e. period, required for each differential process to calculate the corresponding differential value. If not, the supply of training data to each differential process might not catch up with the differential-value calculation. Based on this matter, before execution of the learning task, the deformed-image generating speed and the differential-value calculating speed can be measured, and a required number of image-processing tasks, i.e. image-processing nodes 2, can be designed and installed in the learning system 110.

In addition, it is necessary to avoid the collision of writing of training data into the storage 22 by the image-processing task with the reading of training data from the storage 22. Specifically, for example, while the image-processing task Ai is writing a piece of training data into the storage 22, the learning system needs to prevent each of the differential processes from reading the piece of training data. The image-processing node 2 is also configured to delete pieces of training data stored in the storage 22 in older-first order, in order to prevent the actual capacity of the storage 22 from exceeding a predetermined upper limit of the capacity of the storage 22 due to writing of training data into the storage 22. The learning system therefore need be configured to prevent each differential process from performing reading of a target piece of training data while the image-processing node 2 is deleting the target piece of training data or when the target piece of training data has already deleted.

To avoid these writing and reading collisions, the MPI stored in each node 1 and the MPI stored in the image-processing node 2 can communicate with each other to avoid these writing and reading collisions.

If the average of the bandwidth required to read training data were large as compared with the node-to-node communication performance, it might be difficult for the structure that the image-processing node 2 is separately provided from each node 1 for performing the differential process to speed up the learning task

The above approach according to the fifth embodiment is therefore effective if the average of the bandwidth required to read training data is sufficiently small as compared with the node-to-node communication performance.

At least part of each of the learning systems according to the first to fifth embodiment can be constructed by a hardware module, a software module, or hardware-software hybrid modules. If at least a part of the functions of each of the learning systems according to the first to fifth embodiment is constructed by a software module, a program that implementing the part of the functions can be stored in a storage medium, and a computer can read the program and run it, thus carrying out the at least part of the functions. In this case, the storage medium can be designed as a removable storage medium, such as a magnetic disc or an optical disc, or as a fixed storage medium, such as a hard disc or a memory device.

While illustrative embodiments of the present disclosure have been described herein, the present disclosure is not limited to the embodiment described herein, but includes any and all embodiments having modifications, omissions, combinations (e.g., of aspects across various embodiments), adaptations and/or alternations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

What is claimed is:

1. A learning system for updating at least one parameter for a neural network, the learning system comprising:
a storage storing training data; and
at least one processor configured to perform a plurality of processes,
each of the processes being configured to:
calculate, based on the at least one parameter at a present time and the training data, a differential value for updating the at least one parameter in accordance with backpropagation;
calculate, based on the differential value and the at least one parameter at the present time, a transmission value to be transmitted to the other processes; and
update, based on the transmission values transmitted from the other processes, the at least one parameter at the present time.

2. A learning system for updating at least one parameter for a neural network, the learning system comprising:
a storage storing training data; and
at least one processor configured to perform plural pairs of a differential process and a communication process,
the differential process of each pair being configured to:
calculate, based on the at least one parameter at a present time and the training data, a differential value for updating the at least one parameter in accordance with backpropagation; and
calculate, based on the differential value and the at least one parameter at the present time, a transmission value to be transmitted to the communication processes of the other pairs,
the communication process of each pair being configured to
determine whether the differential process of the corresponding pair has completed calculation of the transmission value;
transmit the transmission value to the communication processes of the other pairs when it is determined that the differential process of the corresponding pair has completed calculation of the transmission value;
transmit a part of the at least one parameter at the present time to the communication processes of the other pairs when it is determined that the differential process of the corresponding pair has not completed calculation of the transmission value; and
update the at least one parameter at the present time based on:
the transmission value transmitted from the communication process of at least one of the other pairs; and
the part of the at least one parameter at the present time transmitted from the communication process of the remaining at least one of the other pairs.

3. The learning system according to claim 1, wherein:
the communication process of each pair is configured to update the at least one parameter at the present time each time the communication process of the corresponding pair transmits the transmission value or the part of the at least one parameter at the present time to the communication processes of the other pairs independently of whether the differential process of the corresponding pair has completed calculation of the transmission value.

4. The learning system according to claim 2, wherein:
the number of the plural pairs is defined based on:
a number of pieces of the training data used by the differential process of each pair;
an optimum number of pieces of the training data used for one updating of the at least one parameter at the present time; and
time required for the differential process of each pair to calculate the transmission value.

5. The learning system according to claim 4, wherein:
the number of pieces of the training data used by the differential process of each pair is represented as A;
the optimum number of pieces of the training data used for one updating of the at least one parameter at the present time is represented as B; and
the number of the plural pairs is defined such that an average of B/A differential processes in the differential processes of all the pairs have completed the transmission value when the communication process of each pair is about to perform the transmission,

6. A learning system for updating at least one parameter for a neural network, the learning system comprising:
a storage storing training data; and
at least one processor configured to perform a plurality of processes,
each of the processes being configured to:
calculate, as a difference value, a compressed value of a difference between a first value of the at least one parameter at a present time that is referred to a first time and a second value of the at least one parameter at a second time that is later than the first time;
calculate, based on the at least one parameter at the first time, the difference value, and the training data, a differential value for updating the at least one parameter in accordance with backpropagation;
compress the differential value;
calculate, based on the encoded differential value and the difference value, a transmission value to be transmitted to the other processes;
obtain the difference value based on the transmission values transmitted from the other processes and the transmission value calculated by the corresponding process; and
update, based on a restored value of the difference value, the at least one parameter at the second time.

7. A learning system for updating at least one parameter for a neural network, the learning system comprising:
a storage storing training data; and
at least one processor configured to perform plural pairs of a differential process and a communication process,
the differential process of each pair being configured to:
calculate, as a difference value, a compressed value of a difference between a first value of the at least one parameter at a present time that is referred to a first time and a second value of the at least one parameter at a second time that is later than the first time;
calculate, based on the at least one parameter at the first time, the difference value, and the training data, a differential value for updating the at least one parameter in accordance with backpropagation;
compress the differential value; and
calculate, based on the encoded differential value and the difference value, a transmission value to be transmitted to the other processes,
the communication process of each pair being configured to:
determine whether the differential process of the corresponding pair has completed calculation of the transmission value;
transmit the transmission value to the communication processes of the other pairs when it is determined that the differential process of the corresponding pair has completed calculation of the transmission value;
transmit the difference value as the transmission value to the communication processes of the other pairs when it is determined that the differential process of the corresponding pair has not completed calculation of the transmission value;
obtain the difference value based on the transmission values transmitted from the other processes and the transmission value calculated by the differential process of the corresponding pair; and
update, based on a restored value of the difference value, the at least one parameter at the second time.

8. The learning system according to claim 6, wherein:
each of the processes is configured to select, as compressing of the encode the differential value, one of:
calculating the product of the differential value and a predetermined matrix;
encoding the differential value while satisfying a distributive law; and
multiplying, by the predetermined matrix, a matrix comprised of the differential values generated by all the processes.

9. The learning system according to claim 8, wherein:
each of the processes is configured to update the predetermined matrix during predetermined times of updating of the at least one parameter.

10. The learning system according to claim 9, wherein:
each of the processes is configured to update the predetermined matrix based on at least one of the past differential values during the predetermined times of updating of the at least one parameter.

11. The learning system according to claim 10, wherein:
each of the processes is configured to update the predetermined matrix based on a principal component analysis of the at least one of the past differential values during the predetermined times of updating of the at least one parameter.

12. The learning system according to claim 1, wherein:
the at least one parameter comprises a plurality of parameters of the neural network; and
a first part of the parameters is shared as a second part of the parameters, or the first part of the parameters has a predetermined relationship with respect to the second part of the parameters.

13. The learning system according to claim 1, wherein:
the neural network comprises a plurality of filters; and
at least one first filter in the filters is shared as at least one second filter in the filters, or the at least one first filter in the filters has a predetermined relationship with respect to the at least one second filter in the filters.

14. The learning system according to claim 13, wherein:
the at least one first filter in the filters is a filter generated by at least one of:
symmetrically converting the at least one second filter with respect to a point,
horizontally reversing the at least one second filter, and
vertically reversing the at least one second filter.

15. The learning system according to claim 1, further comprising:
at least one second processor configured to deform prepared images to generate deformed images as the training data.

16. A program product usable for the learning system according to claim 2, the program product comprising:
a non-transitory computer-readable medium; and
a set of computer program instructions embedded in the computer-readable medium, the instructions causing the at least one processor to perform at least one of:
the differential process of each pair; and
the communication process of the corresponding pair.

17. A learning method for updating at least one parameter for a neural network based on a plurality of processes executed by at least one processor, the learning method, by each of the processes, comprising:
calculating, based on the at least one parameter at a present time and training data stored in a storage, a differential value for updating the at least one parameter in accordance with backpropagation;
calculating, based on the differential value and the at least one parameter at the present time, a transmission value to be transmitted to the other processes; and
updating, based on the transmission values transmitted from the other processes, the at least one parameter at the present time.

18. A learning method for updating at least one parameter for a neural network based on plural pairs of a differential process and a communication process executed by at least one processor, the learning method comprising:
calculating, by the differential process of each pair based on the at least one parameter at a present time and training data stored in a storage, a differential value for updating the at least one parameter in accordance with backpropagation;
calculating, by the differential process of each pair based on the differential value and the at least one parameter at the present time, a transmission value to be transmitted to the communication processes of the other pairs;
determining, by the communication process of each pair, whether the differential process of the corresponding pair has completed calculation of the transmission value;
transmitting, by the communication process of each pair, the transmission value to the communication processes of the other pairs when it is determined that the differential process of the corresponding pair has completed calculation of the transmission value;
transmitting, by the communication process of each pair, a part of the at least one parameter at the present time to the communication processes of the other pairs when it is determined that the differential process of the corresponding pair has not completed calculation of the transmission value; and
updating, by the communication process of each pair, the at least one parameter at the present time based on:
the transmission value transmitted from the communication process of at least one of the other pairs; and
the part of the at least one parameter at the present time transmitted from the communication process of the remaining at least one of the other pairs.

19. A learning method for updating at least one parameter for a neural network based on a plurality of processes executed by at least one processor, the learning method, by each of the processes, comprising:
calculating, as a difference value, a compressed value of a difference between a first value of the at least one parameter at a present time that is referred to a first time and a second value of the at least one parameter at a second time that is later than the first time;
calculating, based on the at least one parameter at the first time, the difference value, and training data stored in a storage, a differential value for updating the at least one parameter in accordance with backpropagation;
compressing the differential value;
calculating, based on the encoded differential value and the difference value, a transmission value to be transmitted to the other processes;
obtaining the difference value based on the transmission values transmitted from the other processes and the transmission value calculated by the corresponding process; and
updating, based on a restored value of the difference value, the at least one parameter at the second time.

20. A learning method for updating at least one parameter for a neural network based on plural pairs of a differential process and a communication process executed by at least one processor, the learning method comprising:
calculating, by the differential process of each pair, a difference value indicative of a compressed value of a difference between a first value of the at least one parameter at a present time that is referred to a first time and a second value of the at least one parameter at a second time that is later than the first time;
calculating, by the differential process of each pair based on the at least one parameter at the first time, the difference value, and training data stored in a storage, a differential value for updating the at least one parameter in accordance with backpropagation;
compressing, by the differential process of each pair, the differential value;
calculating, by the differential process of each pair based on the encoded differential value and the difference value, a transmission value to be transmitted to the other processes;
determining, by the communication process of each pair, whether the differential process of the corresponding pair has completed calculation of the transmission value;
transmitting, by the communication process of each pair, the transmission value to the communication processes of the other pairs when it is determined that the differential process of the corresponding pair has completed calculation of the transmission value;
transmitting, by the communication process of each pair, the difference value as the transmission value to the communication processes of the other pairs when it is determined that the differential process of the corresponding pair has not completed calculation of the transmission value;
obtaining, by the communication process of each pair, the difference value based on the transmission values transmitted from the other processes and the transmission value calculated by the differential process of the corresponding pair; and
updating, by the communication process of each pair based on a restored value of the difference value, the at least one parameter at the second time.
